(19) United States
(12) Patent Application Publication
(10) Pub. No.: US 2010/0265525 A1
(43) Pub. Date: Oct. 21, 2010

(54) IMAGE PROCESSING APPARATUS, IMAGE FORMING APPARATUS, AND IMAGE PROCESSING METHOD

(75) Inventor: Takahiro Hagiwara, Chiba-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/762,849

(22) Filed: Apr. 19, 2010

Related U.S. Application Data
(60) Provisional application No. 61/170,930, filed on Apr. 20, 2009.

(51) Int. Cl. H04N 1/60; G06K 9/36

(52) U.S. Cl. 358/1.9; 382/166

(57) ABSTRACT

An image processing apparatus includes: a color-data acquiring unit configured to acquire, for each of plural kinds of color components for defining colors of respective plural pixels that form image data, color data of the respective plural kinds of color components; plural compression processing units separately provided in association with the respective plural kinds of color components and configured to compress in order, for each of the color components, the color data of the color components acquired by the color-data acquiring unit according to arraying order of the color data in the image data; a packed-data generating unit configured to generate, for each of the color components, packed data as data packaged in the order of the compression by the compression processing unit while associating a predetermined volume of compressed data in which the data is arrayed in the order of the compression by the respective plural compression processing units and identification information indicating the color components corresponding to the compressed data; and a combined-compressed-data output unit configured to output combined compressed data obtained by combining a plurality of the packed data of the color components generated by the packed-data generating unit such that the packed data is arrayed in the order of the generation.

### CROSS-REFERENCE TO RELATED APPLICATION

This application is based upon and claims the benefit of priority from U.S. provisional application 61/170930, filed on Apr. 20, 2009, the entire contents of which are incorporated herein by reference.

### TECHNICAL FIELD

This specification relates to a technique for processing for compressing and expanding image data.

### BACKGROUND

In the past, in image forming apparatuses such as a MFP (Multi Function Peripheral), a printer, and a copying machine, when plural copies of a file including plural pages are printed, electronic sort processing for printing copies of documents in page order of the original file one by one is performed. In the electronic sort processing, an image data file to be printed is temporarily stored in a storage device such as a HDD (Hard Disc Drive) or a memory in an image forming apparatus and, every time a copy is printed, a circuit or the like configured to control image formation processing reads the image data file from the storage device and performs printing. The printing performed by using such electronic sort processing is convenient because it is unnecessary to perform mechanical sorting by a sorter or the like.

In the electronic sort processing, when the image data file to be printed is temporarily stored in the storage device, usually, image data is compressed and stored. When the image data file is printed, the compressed image data is expanded to perform print processing.

Print image quality of image forming apparatuses is improved year by year. In order to perform higher quality printing, it is necessary to handle print image data at high resolution and a large number of gradations compared with the past. Therefore, in order to maintain high image quality, it is necessary to prevent a compression ratio in compression processing in electronic sort from being set too high. However, if the compression ratio is too low, a data volume increases. Therefore, when compressed data has to be stored in a HDD or the like for the electronic sort processing or the like, it takes time to write out the compressed data to the HDD or read the compressed data from the HDD, leading to a fall in speed of printing.

### DESCRIPTION OF THE DRAWINGS

FIG. 1 is a system diagram of the configuration of a MFP (Multi Function Peripheral) as an image processing apparatus according to a first embodiment and a system including the MFP;

FIG. 2 is a control block diagram for explaining functions of the MFP according to the embodiment;

FIG. 3 is a diagram of the data structure of compressed data including plural packed data output by a packed-data generating circuit and a packed-data generation control circuit;

FIG. 4 is a diagram of the structure of compressed data including plural packed data stored in a HDD;

FIG. 5 is a flowchart for explaining compression processing by the MFP;

FIG. 6 is a flowchart for explaining a flow of expansion processing executed by the MFP;

FIG. 7 is a timing chart of timing when expanded data of two components (components A and B) is generated when compressed data having a relatively small difference of compression ratios among respective kinds of data is subjected to expansion processing;

FIG. 8 is a diagram of an example of a data structure in which compression ratios are substantially different among the respective kinds of data;

FIG. 9 is a timing chart of timing of expansion processing for two kinds of compressed data having substantially different compression ratios;

FIG. 10 is a control block diagram for explaining functions of a MFP according to a second embodiment;

FIG. 11 is a diagram of the data structure of compressed data in the second embodiment;

FIG. 12 is a flowchart for explaining a flow of compression processing by the MFP according to the second embodiment;

FIG. 13 is a flowchart for explaining a flow of expansion processing by the MFP according to the second embodiment;

FIG. 14 is a control block diagram for explaining functions of a MFP according to a third embodiment;

FIG. 15 is a diagram of the data structure of compressed data generated by functions of a compressing unit and a packed data unit in the third embodiment;

FIG. 16 is a control block diagram for explaining functions of a MFP according to a fourth embodiment; and

FIG. 17 is a control block diagram for explaining functions of a MFP according to a fifth embodiment.

### DETAILED DESCRIPTION

Embodiments of the present invention are explained below with reference to the accompanying drawings.

This specification relates to an image processing apparatus including: a color-data acquiring unit configured to acquire, for each of plural kinds of color components for defining colors of respective plural pixels that form bitmap image data set as a processing target, color data of the respective plural kinds of color components; plural compression processing units separately provided in association with the respective plural kinds of color components and configured to compress in order, for each of the color components, the color data of the color components acquired by the color-data acquiring unit according to arraying order of the color data in the bitmap image data; a packed-data generating unit configured to generate, for each of the color components, packed data as data packaged in the order of the compression by the compression processing unit while associating a predetermined volume of compressed data in which the data is arrayed in the order of the compression by the respective plural compression processing units and identification information indicating the color components corresponding to the compressed data; and a combined-compressed-data output unit configured to output combined compressed data obtained by integrally combining a plurality of the packed data of the color components generated by the packed-data generating unit such that at least the packed data for each of the color components is arrayed in the order of the generation by the packed-data generating unit.

### First Embodiment

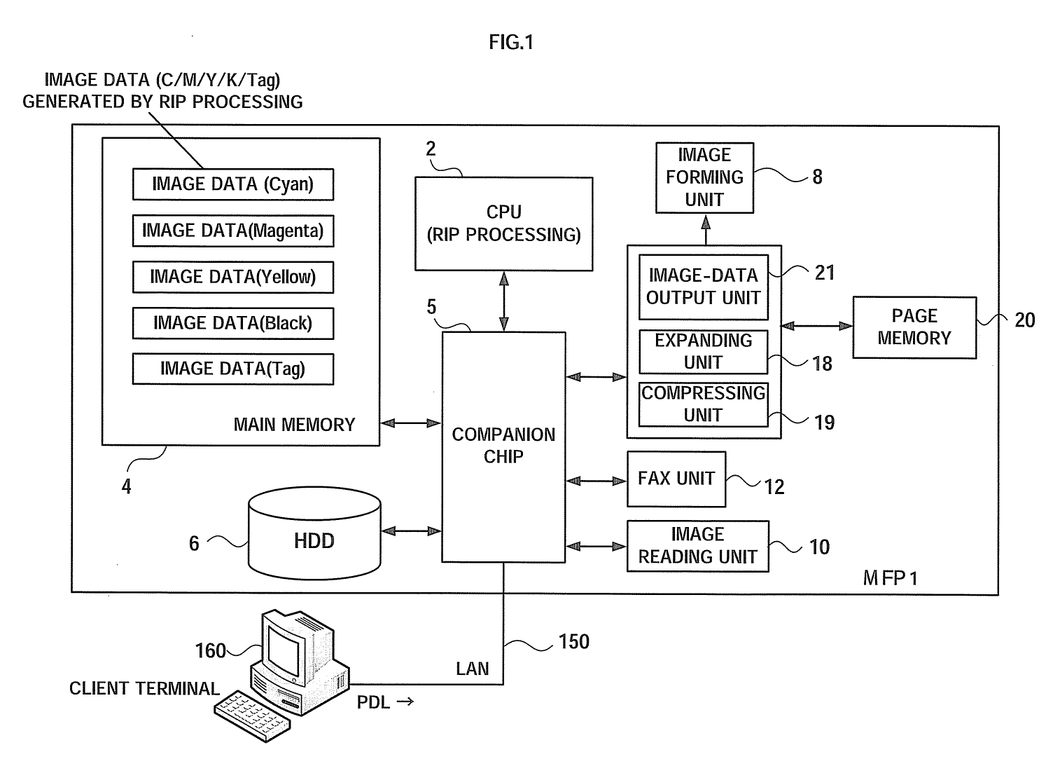

FIG. 1 is a system diagram of the configuration of a MFP (Multi Function Peripheral) 1 as an image processing apparatus according to a first embodiment and a system including the MFP 1. The system is configured by connecting a MFP 1 and a client terminal 160 via a network 150. The configuration of apparatuses included in the system is explained below.

The MFP 1 according to this embodiment is a multifunction peripheral device including plural functions of a printer, a scanner, a facsimile, and the like. When the MFP 1 according to this embodiment receives a print job file written in a page description language (hereinafter referred to as “PDL file”) from a client such as the client terminal 160, the MFP 1 can apply image formation processing to a sheet such as paper or an OHP sheet on the basis of the acquired PDL file.

The “PDL file” is a text file generated by the page description language (PDL) for each of pages to be printed. The MFP 1 forms an image on the basis of the PDL file. As the PDL, there are PostScript (registered trademark of Adobe Systems Incorporated in the United States), PDF, PCL, XPS, and the like.

When the MFP 1 as the image processing apparatus receives the PDL file as a print job, a RIP (Raster Image Processor) unit analyzes the PDL file and converts a page to be printed into a bitmap on the basis of conditions designated by the PDL file.

When the MFP 1 prints plural copies of a file including plural pages and is set to execute electronic sort processing, the MFP 1 temporarily stores image data converted into a bitmap by the RIP processing into an HDD (Hard Disc Drive) 6 in order to perform electronic sort. In temporarily storing the image data, the MFP 1 performs processing for compressing the image data in order to reduce a data volume and perform write-out to the HDD 6 as quickly as possible, i.e., increase transfer speed of the image data to the HDD 6.

The bitmap image data is formed by an aggregate of data for respective pixels of five kinds in total including four kinds of color data corresponding to components of four colors cyan, magenta, yellow, and black and Tag data indicating what kind of image (a character, a photograph, etc.) an image displayed by the pixels is, i.e., indicating an attribute of the pixels. Although the explanation of this embodiment is based on CMYK, the present invention is not limited to this and may be carried out with RGB or CMY data.

The MFP 1 according to this embodiment compresses, as the compression processing, the data corresponding to the components of the four colors and the Tag data for each of the kinds of data. The MFP 1 performs processing for generating data packed as a set (packed data) by dividing the data of each of the kinds by a fixed volume.

The configuration of the MFP 1 according to this embodiment for realizing the functions explained above is explained below.

The MFP 1 according to this embodiment includes a CPU 2, a main memory 4, a companion chip 5, the HDD 6, an image forming unit 8, an image reading unit 10, a facsimile unit 12, a display panel unit 14, an operation input unit 16, a compressing unit 18, an expanding unit 19, a page memory 20, an image-data output unit 21, and a packed data unit 30.

The CPU 2 instructs execution of various kinds of processing in the MFP 1 such as image processing including RIP processing in the MFP 1, image formation processing on a sheet such as paper, and image reading processing for copying and scanning. The CPU 2 can realize various functions by executing computer programs stored in storage devices such as the main memory 4 and the HDD 6. The CPU 2 in this embodiment reads an image processing program to thereby realize a compression processing control function and an expansion processing control function for performing overall control such as start and end of compression processing and expansion processing explained later. The CPU 2 also realizes the RIP processing function by reading a RIP processing program. The CPU 2 may be substituted by other processors such as a MPU (Micro Processing Unit) that can execute equivalent arithmetic processing.

The main memory 4 stores computer programs for executing the image processing such as the RIP processing, the image formation processing, and the like. In the image formation processing, the main memory 4 temporarily stores image data generated by the RIP processing and is used as a work area for various applications. Further, the main memory 4 has a function of temporarily storing, for example, a signal of an image forming job or the like acquired via the network 150 and an operation input signal from the operation input unit 16. The main memory 4 can include, for example, a RAM (Random Access Memory), a ROM (Read Only Memory), a DRAM (Dynamic Random Access Memory), a SRAM (Static Random Access Memory), a VRAM (Video RAM), or a flash memory.

The companion chip 5 is a chip (an integrated circuit) of integrated modules having, for example, a function of an interface for the main memory 4, the HDD 6, the network 150, and the like and a function of a general-purpose I/O port. PDL data acquired via the network 150 and various data such as bitmap image data subjected to the RIP processing by the function of the CPU 2 are transferred among these kinds of hardware via the companion chip 5.

The HDD 6 is an auxiliary storage device configured to store various kinds of information in the MFP 1. The HDD 6 in this embodiment temporarily stores, for the electronic sort processing and the like, bitmap image data compressed by the compressing unit 18 explained later. In this embodiment, the HDD is illustrated as the auxiliary storage device of the MFP 1. However, the auxiliary storage device is not limited to this. For example, a flash memory, a SSD (Solid State Drive), or a magnetic disk other than the HDD can also be used.

The image forming unit 8 is a printer unit configured to apply image formation (printing) processing to a sheet such as paper, for example, when the MFP 1 acquires an image forming job via the network 150 or when the MFP 1 reads an original document with the image reading unit 10 and copies the original document. The image forming unit 8 includes, for example, a transfer device configured to transfer a toner image generated on the basis of a bitmap image generated by the RIP processing onto a sheet and a fixing device configured to fix the transferred toner image on the sheet.

The image reading unit 10 is a general image reading apparatus included in a copying machine, an image scanner, or the like. The image reading unit 10 is used in copying an original document or scanning the original document.

The facsimile unit 12 is an apparatus configured to transmit and receive a facsimile signal in the MFP 1.

The display panel unit 14 displays various kinds of information such as setting information and an operation state of the MFP 1.

The operation input unit 16 is used to perform operation for designating conditions for copying and scanning and inputting a facsimile number. The operation input unit 16 can include, for example, input keys for numbers, a keyboard, or a mouse. The display panel unit 14 can realize a part or all of the functions of the operation input unit 16 by including a touch panel display.

The compressing unit 18 performs processing for compressing image data generated by subjecting a PDL file acquired via the network 150 to the RIP processing with the RIP unit in order to temporarily store the image data in the HDD 6. The compressing unit 18 in this embodiment includes an ASIC (Application Specific Integrated Circuit) as a processing circuit. The compressing unit 18 does not only include the ASIC alone. The CPU 2 may read a computer program to realize a compressing unit. A circuit such as the ASIC and the CPU 2 may realize a compressing unit in cooperation with each other. Specifically, the compressing unit 18 has a function of performing compression processing for bitmap image data obtained by subjecting an acquired PDL file to the RIP processing, i.e., five kinds of data in total including data corresponding to the color components of the four colors and Tag data indicating an attribute of an image. The “attribute” is additional information indicating a kind of an image such as a character, graphics, or a photograph and is added for each of pixels of image data.

The expanding unit 19 performs processing for expanding compressed data compressed by the compressing unit 18 and stored in the HDD 6 to a bitmap image.

The page memory 20 is a storage device configured to temporarily store image data for one page or more. When image data for one page expanded by the expanding unit 19 is output to the image forming unit 8, the page memory 20 temporarily stores the image data. By outputting the image data to the image forming unit 8 after temporarily storing the image data in the page memory 20, it is possible to prevent data transfer from being interrupted because of a factor such as disturbance when the image data is output.

The image-data output unit 21 is an interface for transferring image data to the image forming unit 8 as a printer.

The configuration of the MFP 1 according to this embodiment is as explained above.

As a system component other than the MFP 1 of the system configuration shown in FIG. 1, the network 150 is a communication network including, for example, the Internet, a LAN (Local Area Network), or a WAN (Wide Area Network)

The client terminal 160 connected to the network 150 outputs, for example, an image forming job for a PDL file or the like to the MFP 1 via the network 150. The client terminal 160 is a terminal apparatus such as a computer.

An image processing method by the MFP 1 according to this embodiment and, in particular, processing for compressing image data generated by subjecting PDL data to the RIP processing and processing for expanding compressed data are explained below.

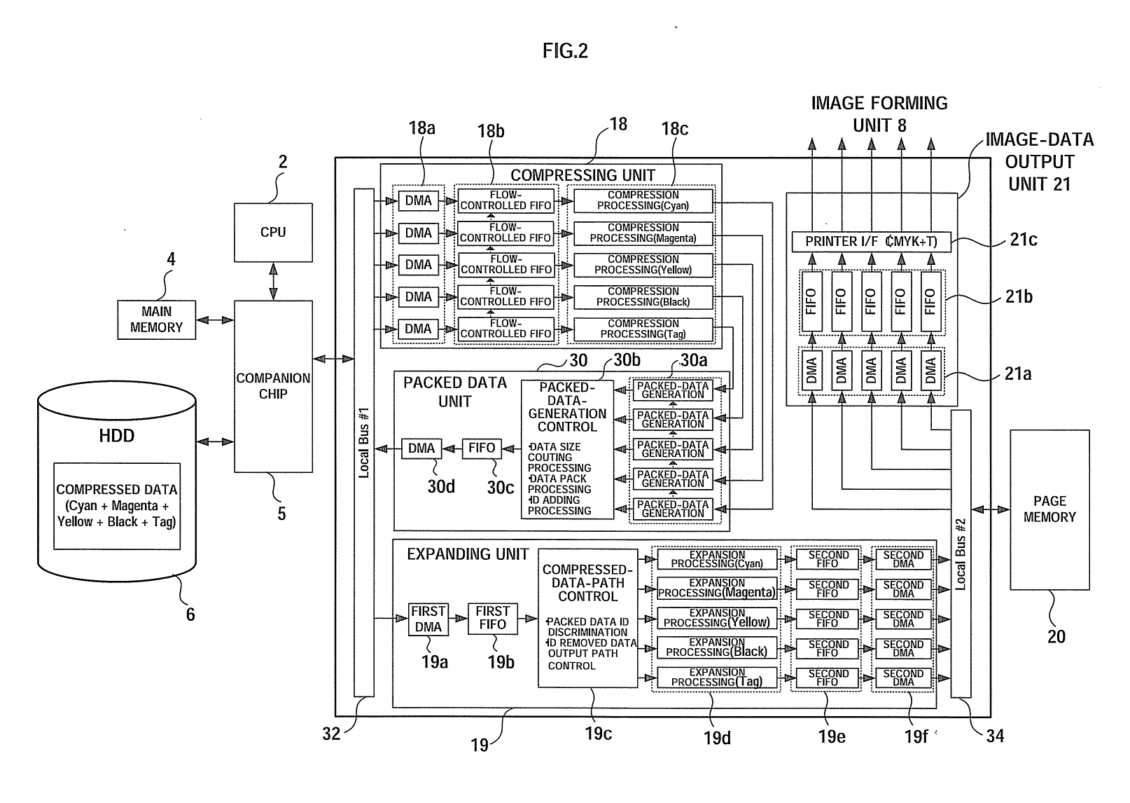

FIG. 2 is a control block diagram for explaining functions of the MFP 1 according to this embodiment. The MFP 1 according to this embodiment includes functional blocks of the compressing unit 18, the packed data unit 30, the expanding unit 19, and the image-data output unit 21. A first bus (Local Bus #1) 32 is arranged between the compressing unit 18 and expanding unit 19 and the companion chip. A second bus (Local Bus #2) 34 is arranged between the expanding unit 19 and the page memory 20 and image-data output unit 21. Data transfer among the circuits is performed via the first bus 32 and the second bus 34.

As explained above, the compressing unit 18 has a function of compressing image data including data of the color components of the four colors and Tag data for each of the data. The compressing unit 18 in this embodiment includes the ASIC. The ASIC included in the compressing unit 18 includes five channels respectively corresponding to the five kinds of data in total including the data of the colors and the Tag data and includes, in the channels, circuits for respectively executing compression processing corresponding to the data. Specifically, the compressing unit 18 includes, for each of the channels corresponding to the data, a DMA (Direct Memory

Access) circuit 18a, a flow-controlled FIFO (First In First Out) circuit 18b, and a compression processing circuit 18c.

In the following explanation, in some case, as circuits corresponding to the respective kinds of data, for example, the DMA circuit 18a corresponding to yellow is described as “DMA 18a/Y” and the compression processing circuit 18c corresponding to black is described as “DMA 18c/K”. The same holds true in the following explanation concerning other control blocks.

The DMA circuits 18a are direct memory access circuits configured to perform processing for transferring bitmap image data generated by subjecting a PDL file to the RIP processing and temporarily stored in the main memory 4 from the main memory 4 to the compression processing circuits 18c.

The flow-controlled FIFO circuits 18b are circuits configured to output, in order of input, data transferred from the DMA circuits 18a. The flow-controlled FIFO circuits 18b have a flow control function for controlling, for each of the channels of the components, an amount of data transferred to the compression processing circuits 18c. The DMA circuits 18a and the flow-controlled FIFO circuits 18b are also collectively referred to as color-data acquiring units.

The compression processing circuits 18c perform processing for compressing data. Since the compression processing is processing for temporarily compressing image data in order to execute the electronic sort processing or the like, deterioration in image quality is undesirable. Therefore, the compression processing circuits 18c compress the data in reversible compression processing. It goes without saying that the compression processing circuits 18c may compress the data in irreversible compression processing when necessary. The compression processing circuits 18c have a number of data measuring function for measuring the number of data input to the compression processing circuits 18c and the number of data output from the compression processing circuits 18c.

The functions of the compressing unit 18 and the circuit configuration for realizing the functions are as explained above.

The packed data unit 30 divides, by a data size designated in advance, respective compressed data of the channels compressed by the compressing unit 18 and adds, to the divided compressed data, channel IDs indicating to which channels the compressed data corresponds, i.e., which kind of data among the data of the color components of the four colors and the Tag data the compressed data is. In this way, the packed data unit 30 generates a set of packed data. The packed data unit 30 arranges, in order of the generation as the packed data, the respective packed data generated from the channels and generates one compressed data obtained by combining plural packed data (combined compressed data). The packed data unit 30 also includes an ASIC and includes, as circuits, packed-data generating circuits 30a, a packed-data-generation control circuit 30b, an FIFO circuit 30c, and a DMA circuit 30d. The packed-data generating circuit 30a is provided for each of the five channels respectively corresponding to the five kinds of data. The packed-date-generation control circuit 30b, the FIFO circuit 30c, and the DMA circuit 30d configure a combined-compressed-data output unit.

The packed-data generating circuits 30a perform processing for dividing compressed data output from the compression processing circuits 18c of the channels by a data size designated in advance and giving, to the top of the divided data, channel IDs (identification information) indicating from which channels the data is output. The processing for dividing compressed data by the size designated in advance is performed by using storage areas having the same capacity functioning as buffers included in the packed-data generating circuits 30a for the channels. Compressed data output from the compression processing circuits 18c is transferred to the storage areas functioning as the buffers of the packed-data generating circuits 30a of the same channels and accumulated in the storage areas in order. When the buffers of the packed-data generating circuits 30a are filled with the compressed data accumulated in the storage areas, the packed-data generating circuits 30a add channels ID to the top of the data accumulated in the buffers and output the data as one packed data separated from a series of compressed data. By setting the capacities of the buffers of the channels the same, packed data output from all the channels can be data of the same volume.

The packed-data-generation control circuit 30b controls and monitors the packed-data generation processing, the processing for adding the channels ID in the packed data generation, and the like by the packed-data generating circuits 30a. The packed-data-generation control circuit 30b has a number of packed data counting function for counting, for each of the channels, the number of packed data output from the packed-data generating circuits 30a of the channels.

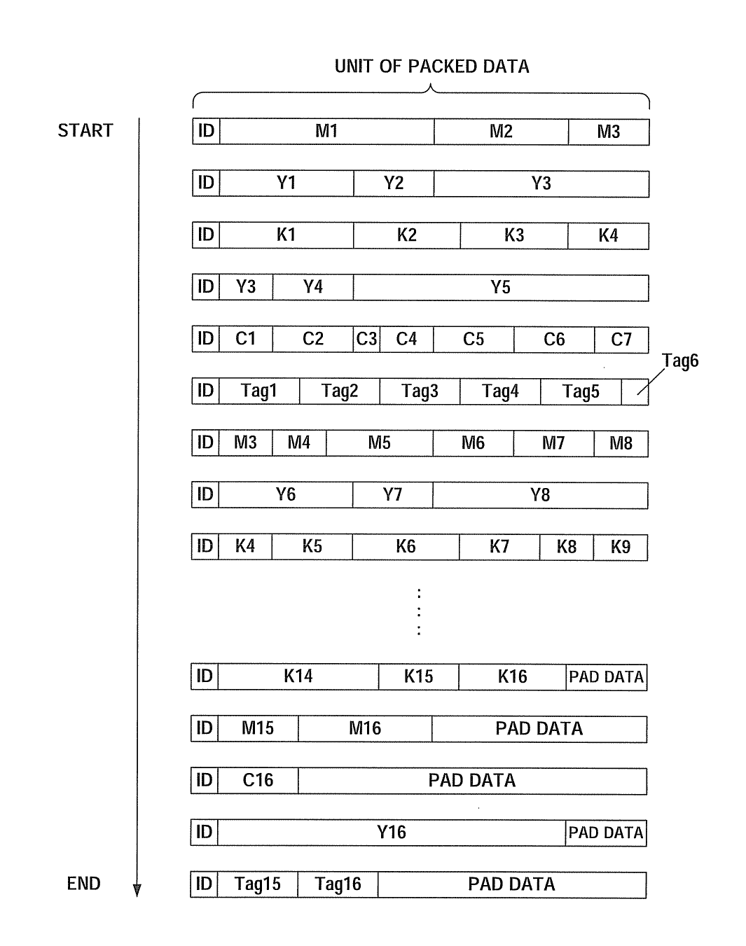

The data structure of the packed data output by the packed-data generating circuits 30a of the channels and the packed-data-generation control circuit 30b is explained. FIG. 3 is a diagram of the data structure of compressed data including plural packed data output by the packed-data generating circuits 30a and the packed-data-generation control circuit 30b. In FIG. 3, the packed data output from the packed-data generating circuits 30a are arranged from up to down in order of the output. The width in the left to right direction in FIG. 3 indicates a data size. The left ends of the respective packed data are the tops of the data to which channel IDs are added.

In FIG. 3, “M”, “Y”, “K”, and “C” of “M1”, “Y2”, “K3”, and “C4” and the like respectively mean data of magenta, yellow, black, and cyan. Numbers such as “1”, “2”, “3”, and “4” indicate order numbers of unit data in the data of the components.

The “unit data” means data formed by data corresponding to a fixed number of pixels in a bitmap image before compression. The “unit data” is a concept used in this specification for convenience of explanation. In actual processing by the MFP 1, unit data is processed without an order number thereof being specifically recognized. The unit data is, for example, data for one line of pixels in the bitmap image or data for a predetermined number of pixels. When the data for one line of the pixels is the unit data, data for each line from the top of one page of the bitmap image is the unit data. In this case, for example, “M1” means compressed data obtained by compressing data of a first line of the magenta component. When the data for the predetermined number of pixels, for example, one hundred pixels is the unit data, data of every one hundred pixels from the first pixel on the upper left of the page is the unit data. When the data for one hundred pixels is the unit data, “Y3” indicates data obtained by compressing data from a two hundred first pixel to a three hundredth pixel of the yellow component. The compression processing is performed for each of the pixels of the bitmap image. Therefore, when the unit data includes plural pixels, data having different compression ratios are mixed in the unit data. Therefore, when compressed data of “M1” and “M2” shown in FIG. 3 are compared, since there are a larger number of data having low compression ratios as an average in M1 than in M2, a data size after compression is larger in M1 than in M2.

As explained above, the packed data is output as one packed data every time the packed data for the capacities of the buffers is accumulated from the packed-data generating circuits 30a of the channels. Therefore, as a ratio of data having low compression ratios and large volumes is larger, the capacities of the buffers are filled earlier and the data is output as the packed data. In the case of FIG. 3, first, packed data of magenta (a part of M1, M2, and M3) is output and, next, packed data of yellow (a part of Y1, Y2, and Y3) is output. Thereafter, packed data is output in order of black, yellow for the second time, and cyan. In this case, a compression ratio of the cyan data is high in average compared with the magenta data output first. Therefore, unit data larger in number than the packed data of magenta and the like output earlier is included in one packed data. Specifically, compressed data of a large number of unit data is necessary until the capacity of the buffer of the channel for cyan is filled with compressed data of cyan. Therefore, the first packed data of cyan is output at timing later than timing of the packed data of magenta, yellow, and the like output earlier. PAD data shown in FIG. 3 is Padding data. The PAD data is data output in order to fill the last gap of the data and is, for example, data including EOR (end of record) indicating the end of data and meaningless data added after the EOR, for example, data such as “0”.

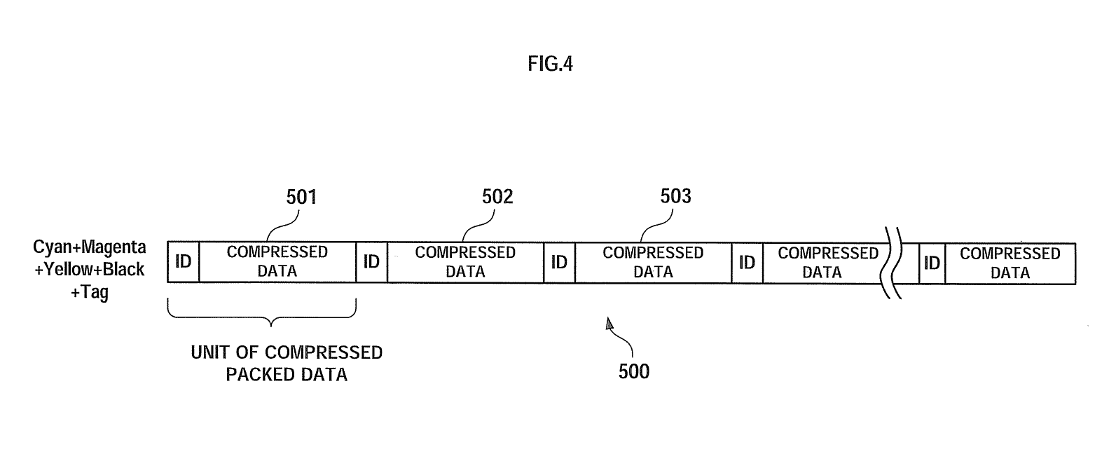

All packed data for one page of the bitmap image are output from the packed data unit 30 as combined compressed data obtained by integrally combining plural packed data shown in FIG. 4 with a compressed data output function realized by the packed-data-generation control circuit 30b, the FIFO circuit 30c, and the DMA 30d and is stored in the HDD 6. FIG. 4 is a diagram of the structure of the combined compressed data including the plural packed data stored in the HDD 6. Combined compressed data 500 stored in the HDD 6 has a data structure in which the kinds of packed data shown in FIG. 3 are arranged in order of the output from the packed data unit 30. When the combined compressed data 500 is generated from the packed data shown in FIG. 3, packed data 501 is packed data including a part of M1, M2, and M3 and packed data 502 is packed data including a part of Y1, Y2, and Y3. In this way, the compressed data in this embodiment is stored in the HDD 6 as one data in which the respective kinds of packed data continue in order of the output.

By forming one combined compressed data including the respective kinds of packed data as in this embodiment, the HDD can perform recording of the compressed data without performing the random access processing. Then, in recording of the compressed data, since the speed of recording in the HDD 6 can be maintained, even when processing for temporarily recording the compressed data in the HDD 6 in order to perform electronic sort or the like, an effect can be obtained that a fall in printing speed can be prevented.

When image formation is actually performed on a sheet, the expanding unit 19 performs processing for expanding the combined compressed data recorded in the HDD 6. The expanding unit 19 in this embodiment disassembles one compressed image data, in which the five kinds of compressed data (packed data) are mixed, using channel IDs in a unit of packed data and outputs the disassembled data to the channels corresponding to the respective kinds of data to perform expansion processing. Like the compressing unit 18, the expanding unit 19 includes an ASIC. The expanding unit 19 includes, as circuits, a first DMA circuit 19a, a first FIFO circuit 19b, a compressed-data-path control circuit 19c, expansion processing circuits 19d, second FIFO circuits 19e, and second DMA circuits 19f. The first DMA circuit 19a is also a combined-compressed-data acquiring unit. The compressed-data-path control circuit 19c is also an identification-information determining unit. The second DMA circuits 19f are also packed-data output units.

The first DMA circuit 19a is a direct memory access circuit configured to extract the combined compressed data from the HDD 6 and transfer the compressed data to the compressed-data-path control circuit 19c and the expansion processing circuits 19d via the first FIFO circuit 19b.

The first FIFO circuit 19b transfers the combined compressed data, which is transferred from the first DMA circuit 19a, to the compressed-data-path control circuit 19c in order of the transfer.

The compressed-data-path control circuit 19c performs processing for inputting packed data included in the transferred compressed data to the expansion processing circuits 19d of the channels corresponding to the packed data. Specifically, the compressed-data-path control circuit 19c functions as an ID-information determining unit to determine channel IDs included in the transferred compressed data and identify which kind of data the packed data included in the compressed data is. The compressed-data-path control circuit 19c performs processing for disassembling, for each of the packed data added with the identified channel IDs, the combined compressed data including continuous plural packed data and inputting the compressed data to the expansion processing circuit 19d of the corresponding channel. For example, when the compressed-data-path control circuit 19c identifies a channel ID indicating packed data of the magenta component, the compressed-data-path control circuit 19c separates the packed data added with the channel ID from the combined compressed data and inputs the packed data to an expansion processing circuit 19d/M for magenta.

The expansion processing circuits 19d expand the input packed data. When the compressing unit 18 compresses data in the reversible compression processing and generates packed data, the packed data is restored to original image data for the packed data by the expansion processing by the expansion processing circuits 19d.

The second FIFO circuits 19e output the data expanded by the expansion processing circuits 19d in order of the input. The second FIFO circuits 19e also have a function of buffers for adjusting timing of output in outputting the expanded data corresponding to the respective channels to the page memory. The second FIFO circuits 19e return plural kinds of data divided in the compression to a state of a series of data.

The second DMA circuit 19f stores the data output from the second FIFO circuits 19e in the page memory 20 via the second bus 34. In the page memory 20, expanded data output from the second DMA circuits 19f of the channels of the expanding unit 19 is sequentially accumulated and, for each kind of data, data included in image data for one page is temporarily stored.

The image-data output unit 21 outputs the expanded data stored in the page memory 20 to the image forming unit 8. The image-data output unit 21 includes an ASIC. The ASIC included in the image-data output unit 21 includes DMA circuits 21a, FIFO circuits 21b, and a printer interface (I/F) 21c.

The DMA circuits 21a and the FIFO circuits 21b have functions same as the same circuits of the compressing unit 18 and the expanding unit 19. The DMA circuits 21a of the channels capture kinds of data corresponding thereto from the page memory. The FIFO circuits 21b output the captured data to the printer interface 21c in order.

The printer interface 21c transfers image data to the image forming unit 8.

The configuration and the functions of the MFP 1 according to this embodiment are as explained above. With the MFP 1 according to this embodiment, when the five kinds of data in total including the data of the four components of CMYK and the Tag data are subjected to the compression processing in the channels corresponding to the kinds of data, the data can be packed as compressed data having a fixed size and the packed data can be stored in the HDD 6 as one compressed data in which the packed data are arranged in order of the packing and output. Consequently, the processing for storing compressed data of image data including plural kinds of data in the HDD 6 can be performed as processing for storing one file. Therefore, since it is possible to perform processing for storing the compressed data in the HDD 6 without performing the random access processing for simultaneously storing plural files, an effect can be obtained that speed of processing for storage in the HDD 6 is maintained and a fall in printing speed is prevented.

Therefore, with the MFP 1 according to this embodiment, even if electronic sort is performed when plural copies of a file including plural pages are printed, it is possible to perform print processing at high speed compared with the system in the past.

A flow of the compression processing and the expansion processing by the MFP 1 according to this embodiment is explained below.

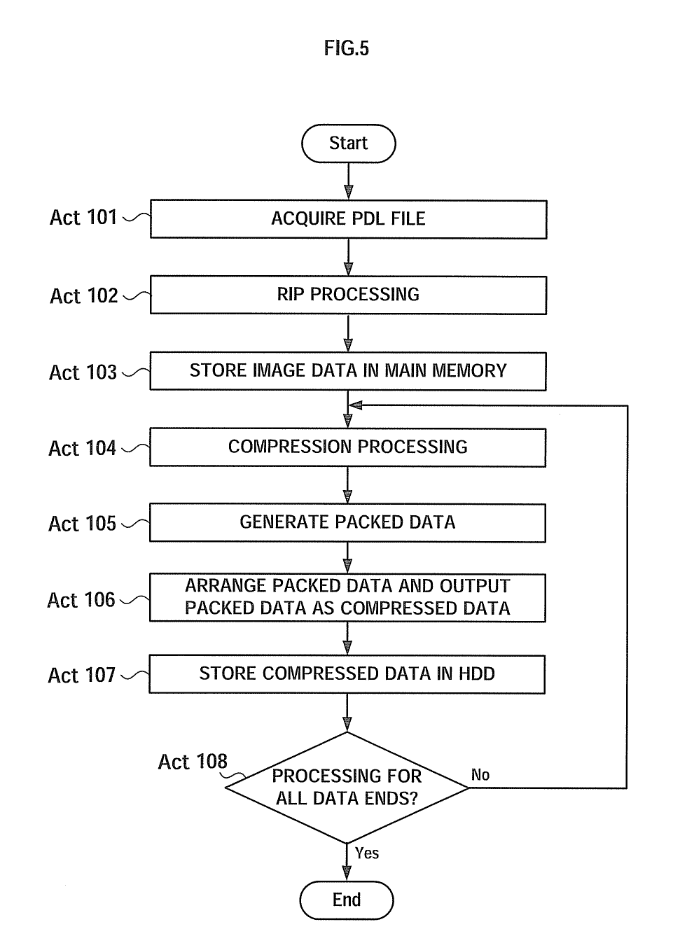

FIG. 5 is a flowchart for explaining the compression processing by the MFP 1.

First, in Act 101, the CPU 2 acquires a PDL file from the client terminal 160 via the network 150.

Subsequently, in Act 102, the RIP unit realized by the CPU 2 performs analysis processing for the acquired PDL file.

In Act 103, the CPU 2 performs processing for temporarily storing bitmap image data for one page generated by RIP processing by the RIP unit in the main memory 4.

In Act 104, the CPU 2 instructs the compressing unit 18 to perform the compression processing for compressing five kinds of data included in the bitmap image data for each of the kinds of data.

In Act 105, the CPU 2 instructs the packed-data generating circuits 30a and the packed-data-generation control circuits 30b of the channels to pack, every time a predetermined volume of compressed data generated by the compression processing circuits 18c of the compressing unit 18 is accumulated, the compressed data as one independent data with channel IDs added to the tops thereof and output the data as packed data.

In Act 106, according to an instruction of the CPU 2, the packed-data-generation control circuit 30b arranges the packed data in order of the output. The CPU 2 instructs the DMA circuit 30d to sequentially transfer the compressed data to the HDD 6.

In Act 107, the CPU 2 instructs the HDD 6 to store the transferred compressed data.

In Act 108, the CPU 2 determines whether processing for applying the compression processing to all the pages of the acquired PDL file and storing the pages in the HDD 6 is executed. If the processing for only a part of the PDL file including the plural pages is completed (No in Act 108), the CPU 2 returns to Act 104 and repeats the compression processing and the processing for storage in the HDD 6. On the other hand, if the processing for all the pages is completed (Yes in Act 108), the CPU 2 ends the compression processing and the processing for storage in the HDD 6.

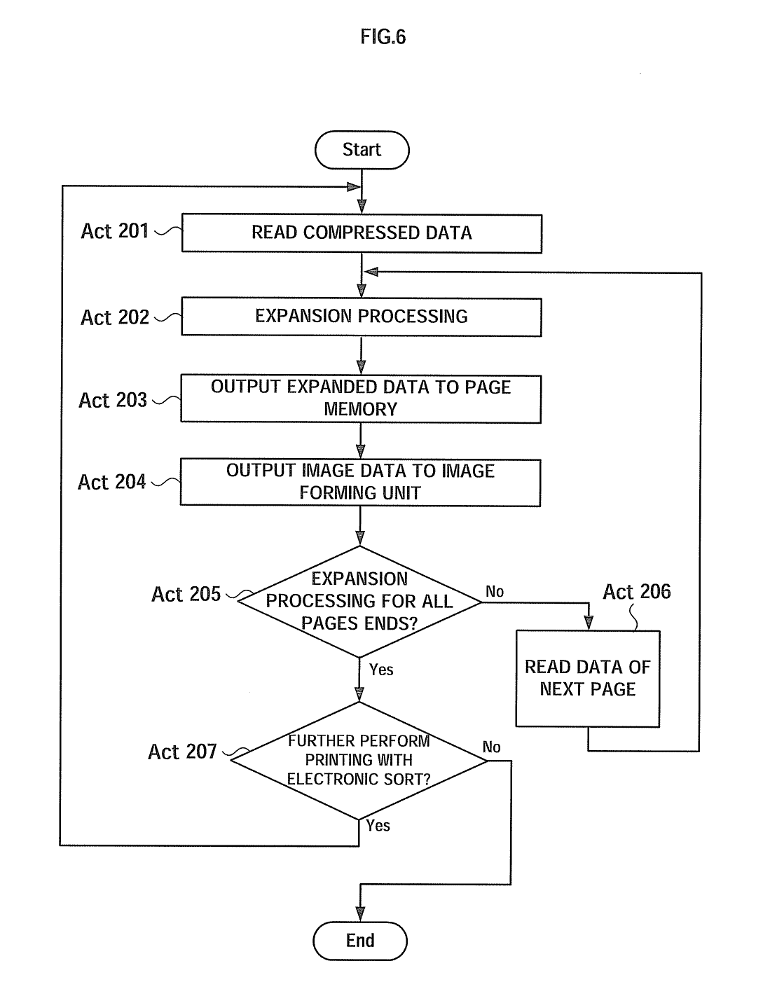

A flow of processing for expanding the compressed data compressed by the processing explained above in order to use the compressed data for image formation processing is explained. FIG. 6 is a flowchart for explaining a flow of the expansion processing executed by the MFP 1.

First in Act 201, the CPU 2 instructs the expanding unit 19 to perform processing for reading compressed data stored in the HDD 6. Specifically, the first DMA circuit 19a extracts the compressed data from the HDD 6. The first FIFO circuit 19b transfers the extracted compressed data to the compressed-data-path control circuit 19c in order. The compressed-data-path control circuit 19c performs processing for discriminating channel IDs at the tops of packed data included in the compressed data and transferring the packed data to the expansion processing circuits 19d of the channels corresponding thereto.

Subsequently, in Act 202, the CPU 2 causes the expansion processing circuit 19d to execute processing for expanding the transferred packed data.

In Act 203, the CPU 2 instructs the second FIFO circuits 19e and the second DMA circuits 19f of the channels to transfer the expanded data to the page memory 20 in order of the expansion. Consequently, in the page memory 20, original image data for one page is stored in a restored state for each of kinds of data.

In Act 204, the CPU 2 instructs the image-data output unit 21 to read the expanded data for each of the kinds of data from the page memory 20 and output the expanded data to the image forming unit 8 at timing when the image-data output unit 21 actually forms an image on a sheet such as paper from the image data.

In Act 205, the CPU 2 determines whether processing for applying the expansion processing to the compressed data of all the pages generated from the acquired PDL file and transferring the expanded data of all the pages to the image forming unit 8 is performed.

If the compressed data of a page as a processing target remains (No in Act 205), in Act 206, the CPU 2 causes the first DMA circuit 19a of the expanding unit 19 to read the compressed data of the remaining next page and repeat the processing from Act 202.

On the other hand, if it is determined that the compressed data of all the pages is processed (Yes in Act 205), the CPU 2 proceeds to Act 207.

In Act 207, the CPU 2 determines whether it is necessary to execute the image formation processing for the same image data again in order to perform the image formation processing for plural copies with the electronic sort processing.

If electronic sort is set and it is necessary to further form an image (Yes in Act 207), the CPU 2 returns to Act 201 and repeats the same processing. On the other hand, if the image formation processing for a necessary number of copies ends or when electronic sort is not set (No in Act 207), the CPU 2 ends the processing.

The flow of the compression processing and the flow of the expansion processing by the MFP 1 according to this embodiment are as explained above.

The processing does not always progress in the order shown in FIGS. 5 and 6.

With the compression processing method according to this embodiment explained above, the five kinds of data in total including the data corresponding to the components of the four colors CMYK and the Tag data are generated as one united compressed data (combined compressed data) and stored in the HDD 6. Therefore, unlike the processing for simultaneously storing plural files, speed of recording in the HDD 6 does not fall and storage in the HDD 6 can be performed more quickly than in the past. When a volume of image data is large, in the case of the system in the past, speed of recording in the HDD 6 falls. However, in the case of the compression processing method according to this embodiment, it is possible to record the image data while maintaining the recording speed. Therefore, with the MFP 1 according to this embodiment, it is possible to perform electronic sort printing of a high-quality image with printing speed maintained.

With the compression processing method according to this embodiment, channel IDs corresponding to kinds of packed data are added to the tops of the packed data and the packed data is arranged in order of generation to generate one compressed data. Therefore, even if the packed data is generated as one compressed data having a data structure in which kinds of data different from one another are mixed, in the expansion processing, it is possible to accurately restore the compressed data to an original image before the compression processing on the basis of order of reading from the HDD 6 and the added channel IDs.

After the compression processing according to this embodiment is performed, when the expansion processing is performed to restore the compressed data to an original bitmap image, in order to allow the compressed data to be accurately restored to the original image for each of the kinds of data while maintaining array order of data in the original bitmap image data, the array structure of the integral compressed data 500 temporarily stored in the HDD 6 needs to be at least in order of the generation of the packed data for each of the kinds of data. Therefore, in this embodiment, it is explained that the packed data is arranged in order of the generation of the packed data for all the kinds of data to generate one compressed data. However, the present invention is not limited to this. Compressed data may be generated such that at least the integral compressed data has a data structure in which the kinds of data are arrayed in order of the generation as the packed data.

In this embodiment, it is explained that the compressing unit 18, the packed data unit 30, the expanding unit 19, and the image-data output unit 21 respectively include the ASICs. However, the present invention is not limited to this. The functions may be realized by a processor reading computer programs such as a compression processing program, a packed-data generating program, an expansion processing program, and an image-data output program for causing the processor such as a MPU to execute the processing method explained above.

### Second Embodiment

A second embodiment is explained below. The MFP 1 according to this embodiment is characterized by further including a function of adjusting frequencies of generation of packed data in the channels respectively corresponding to kinds of data. This is for the purpose of preventing, when compression ratios are substantially different among the five kinds of compressed data including the four kinds of data corresponding to the components of four colors and the Tag data, end time of the expansion processing from substantially deviating between kinds of data having low compression ratios and kinds of data having high compression ratios in the expansion processing.

The expansion processing performed when a difference of compression ratios is smaller than a predetermined value and the expansion processing performed when a difference of compression ratios is larger than the predetermined value are compared to explain a cause of occurrence of the deviation in the expansion processing.

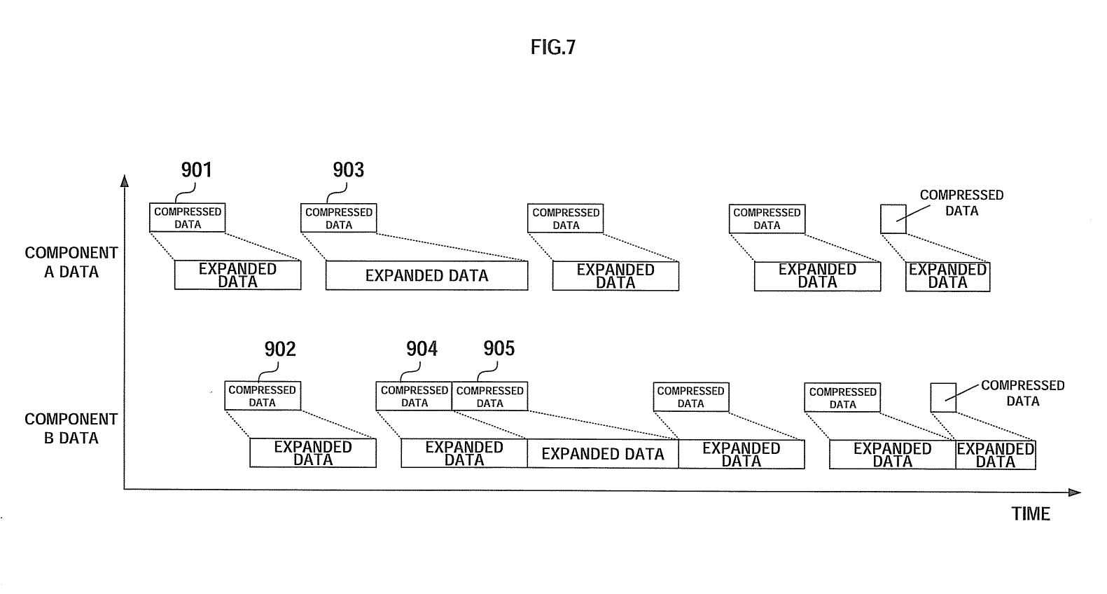

FIG. 7 is a timing chart of timing when expanded data corresponding to two components (components A and B) is generated when compressed data having a difference of compression ratios smaller than the predetermined value is subjected to the expansion processing between the kinds of data shown in FIG. 3. In FIG. 7, to simplify the explanation, it is assumed that the data of two components is subjected to the compression and expansion processing.

The compressed data shown in FIG. 7 has a data structure in which packed data of the two components are arranged in order of generation as the packed data in such a manner that, first, packed data 901 of the component A is present, next, packed data 902 of the component B is present, next, packed data 903 of the component A is present, next, packed data 904 of the component B is present, and, next, packed data 905 of the component B is present. In the compressed data shown in FIG. 7, since a difference of compression ratios of the compressed data is smaller than the predetermined value between the component A and the component B, there is no large difference in frequencies of being output as packed data from the buffers of the packed-data generating circuits 30a. The packed data is alternately arranged. When such compressed data is expanded, the respective kinds of packed data are expanded in order of the arrangement in the compressed data. Therefore, as shown in FIG. 7, deviation of timing when the expansion processing for the last packed data of the kinds ends is small.

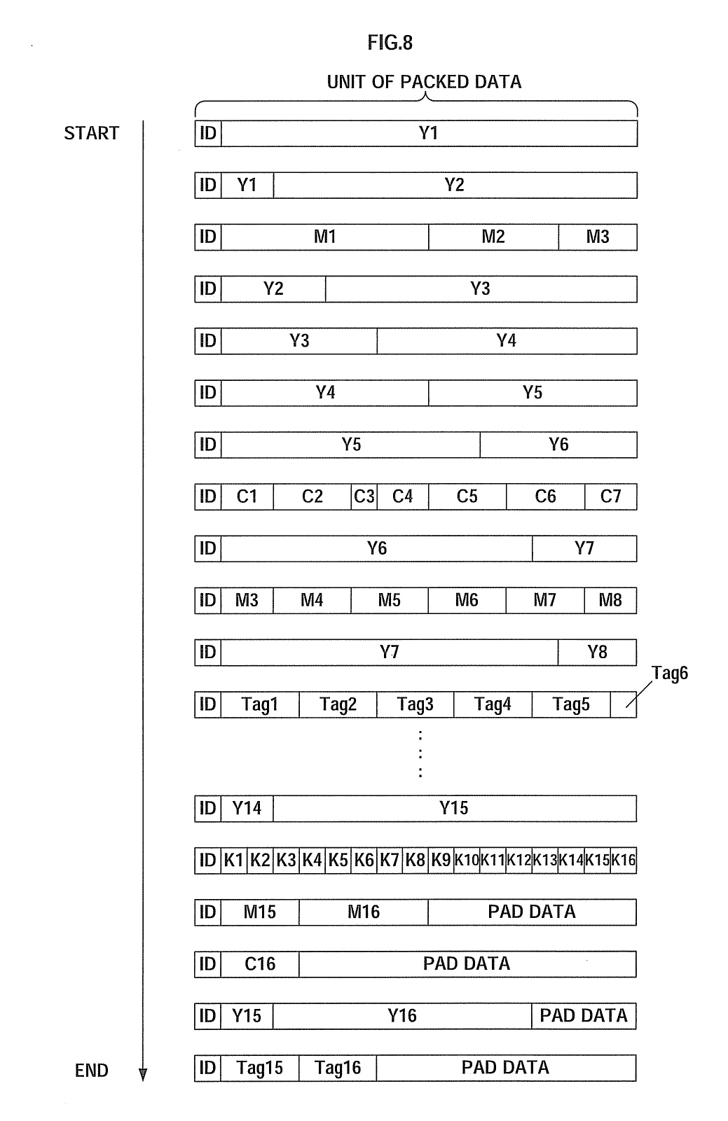

However, as shown in FIG. 8, when compression ratios of the respective kinds of data are substantially different, timing when the expansion processing ends is substantially different among the respective kinds of data. FIG. 8 is a diagram of an example of the data structure of the kinds of data having a large difference of compression ratios. In the structure of compressed data shown in FIG. 8, since data of the yellow component has a low compression ratio compared with the other components, when the data is output from the compression processing circuit and accumulated in the buffer of the packed-data generating circuit, the capacity of the buffer is immediately filled and the data is output as packed data. On the other hand, data of the black component has an extremely high compression ratio. Whereas only a part of unit data of Y1 of yellow is output as packed data, data up to K16 is output as one packed data. A frequency of generation of the packed data of black is substantially low compared with a frequency of generation of the packed data of yellow.

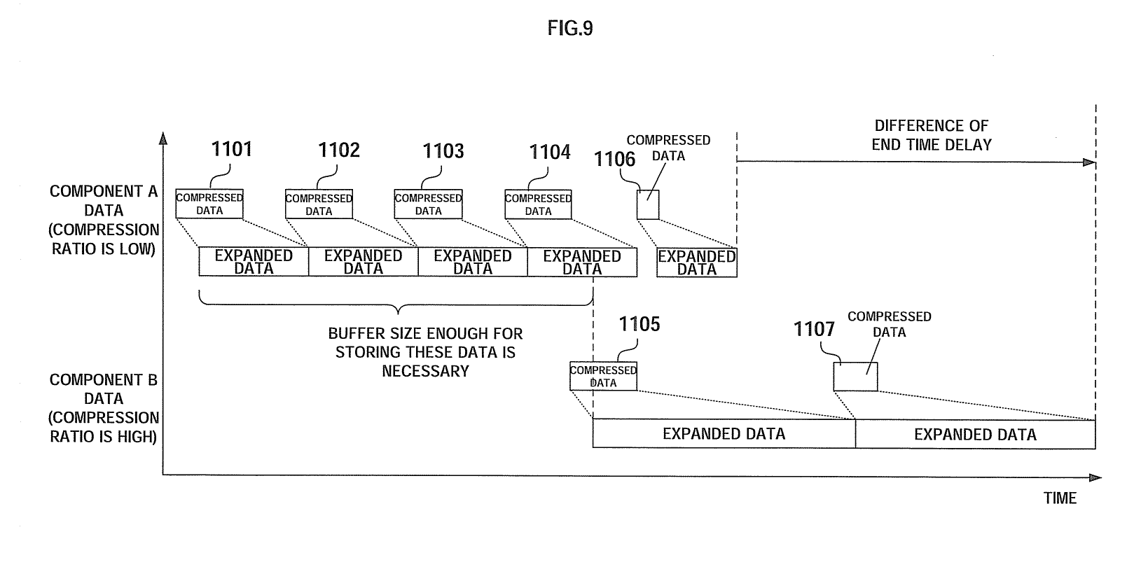

In this way, compression ratios are substantially different among the respective kinds of data. When data having substantially different frequencies of generation of packed data for each of kinds of data is expanded, timing when the expansion processing ends substantially deviates -among the respective kinds of data. FIG. 9 is a timing chart of the expansion processing for compressed data of two components having substantially different compression ratios. The component A is component data having a low compression ratio like the data of the yellow component in FIG. 8. The component B is component data having high compression ratio like the black component. The data structure of the compressed data shown in FIG. 9 is a structure in which packed data 1101, packed data 1102, packed data 1103, and packed data 1104 of the component A are arranged and, next, packed data 1105 of the first component B is arranged, next, packed data 1106 of the component A is arranged, and, lastly, packed data 1107 of the component B is arranged.

When the compressed data having such a data structure is subjected to the expansion processing in order, after the expansion processing for the fourth packed data of the component A is started, the expansion processing for the first packed data of the component B is started. In the case of data having a high compression ratio like the component B, compared with data having a low compression ratio, time required for expanding one packed data becomes long. Therefore, as shown in FIG. 9, finally, a large time lag occurs between timing when the expansion processing for the last packed data 1106 of the component A ends and timing when the expansion processing for the last packed data of the component B ends.

If timing when expanded data is started to be output from the expansion processing circuits deviates among the channels, it is necessary to provide a buffer configured to store expanded data subjected to the expansion processing and output earlier until data subjected to the expansion processing later is output as expanded data. However, as explained above, if a large difference occurs in timing when the expansion processing is started among the respective kinds of data, it is necessary to store a large volume of data until the data expanded later is output.

For example, when two kinds of compressed data corresponding to the two components shown in FIG. 9 are expanded and output, expanded data generated by expanding the first compressed data 1101 of the component A and subsequent expanded data have to be stored until expanded data of the first compressed data 1105 of the component B is generated. Therefore, in a case shown in FIG. 9, it is necessary to provide a large-capacity buffer that can store expanded data from the expanded data of the compressed data 1101 to a part of expanded data of the compressed data 1104. However, such a large-capacity buffer causes an increase in cost of the MFP 1. (On the other hand, when a difference of compression ratios is small among the respective kinds of data and there is little difference in generation frequencies of the respective kinds of packed data as shown in FIG. 7, expanded data of the component A is output and, next, expanded data of the component B is output. Therefore, only a buffer having a capacity enough for storing only a part of data obtained by expanding the first compressed data 901 has to be provided.)

Since the timing when the expansion processing ends deviates, as a result, excess time is required until compressed data is read from the HDD 6 and restored and the image formation processing is started. This causes a fall in speed of the image formation processing, for example, when the image formation processing for plural copies is performed by electronic sort.

Therefore, the MFP 1 according to this embodiment monitors a generation state of packed data for each of kinds of data. The MFP 1 has a function of, concerning a channel in which a large difference occurs in compression ratios among the kinds of data, an output frequency of packed data is low, and timing when the packed data is generated is delayed, forcibly filling the buffer of a packed-data generating circuit 30a′ and preferentially outputting packed data of the channel. With such a function, it is possible increase a generation frequency of packed data concerning data having a high compression ratio and an extremely low frequency of generation of packed data compared with the other kinds of data. It is possible to generate compressed data in which packed data are arranged in good balance among the respective kinds of data. Therefore, an effect can be obtained that, in the expansion processing, it is possible to eliminate deviation of timing when the expansion processing ends among the respective kinds of data. A configuration and functions of this embodiment are explained below. Components same as those in the first embodiment are denoted by the same reference numerals and signs and explanation of the components is omitted.

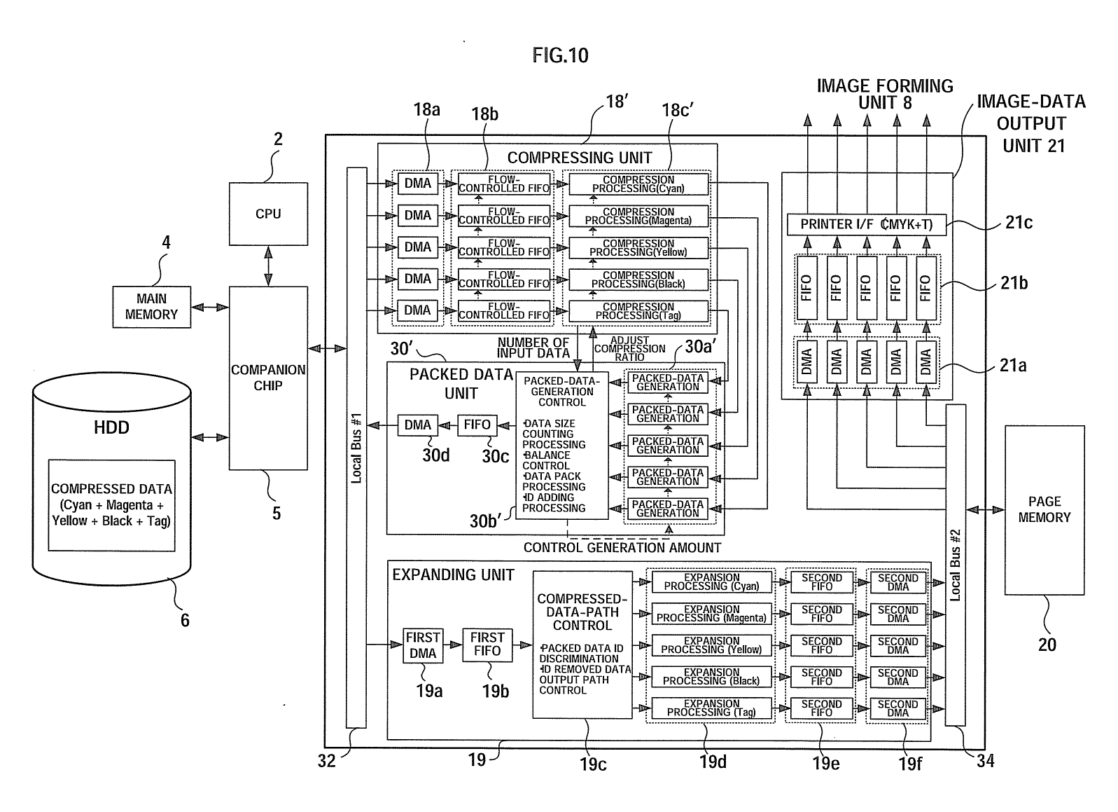

FIG. 10 is a control block diagram for explaining functions of the MFP 1 according to this embodiment. The MFP 1 according to this embodiment includes a compressing unit 18′ and a packed data unit 30′ further including functions not included in the first embodiment. Other control blocks are the same as those in the first embodiment.

Like the compressing unit 18 in the first embodiment, the compressing unit 18′ reads data corresponding to channels from data of five components temporarily stored in the main memory 4 and performs the compression processing. The compressing unit 18′ in this embodiment performs, on the basis of an instruction from the packed data unit 30′ explained later, compression processing obtained by combining the normal compression processing and processing for directly outputting uncompressed data without performing the compression processing. The compressing unit 18′ configured to realize this function includes an ASIC and includes the DMA circuits 18a, the flow-controlled FIFO circuits 18b, and compression processing circuits 18c′.

The DMA circuits 18a and the flow-controlled FIFO circuits 18b are the same as those in the first embodiment.

As explained above, the compression processing circuits 18c′ apply, according to an instruction of a packed-data-generation control circuit 30b′ explained later, in combination, the compression processing for outputting compressed data and the processing for directly outputting uncompressed data without performing the compression processing to data input from the DMA circuits 18a and the flow-controlled FIFO circuits 18b and output data to the packed data unit 30′.

The packed data unit 30′ has a function of monitoring the number of generated packed data of the channels (the generation frequencies) and controlling the compression processing by the compression processing circuits 18c′ such that packed data are output without deviation of the generation frequencies among the kinds of data in addition to the function explained in the first embodiment of packing compressed data of the channels output from the compressing unit 18′ by a fixed volume and generating packed data. The packed data unit 30′ includes an ASIC and includes the packed-data generating circuits 30a′, the packed-data-generation control circuit 30b′, the FIFO circuit 30c, and the DMA circuit 30d.

The packed-data generating circuits 30a′ generate packed data obtained by packing compressed data output from the compression processing circuits 18c′ of the channels by a fixed volume. In the case of this embodiment, for adjustment of a generation frequency of packed data, in some case, compressed data and uncompressed data are output in combination. However, when data equivalent to the capacities of the buffers of the packed-data generating circuits 30a′ are accumulated, the packed-data generating circuits 30a′ output the data as packed data irrespectively of whether the data is compressed data or uncompressed data.

The packed-data-generation control circuit 30b′ monitors generation frequencies of packed data of the components on the basis of, for example, the number of data input to the compression processing circuits 18c′ and the number of packed data output from the packed-data generating circuits 30a concerning the respective kinds of data. When a predetermined condition for determining that a difference occurs in the generation frequencies of the packed data is satisfied, the packed-data-generation control circuit 30b′ controls the compression processing circuit 30a′ of the channel in which the condition is satisfied to output uncompressed data without performing the compression processing. When, with such processing, packed data is output from the channel from which the uncompressed data is output and the deviation of the generation frequencies of the packed data is eliminated, the packed-data-generation control circuit 30b′ controls the compression processing circuits 18c′ to perform the normal compression processing again and output compressed data.

As the predetermined condition for determining that a difference occurs in generation frequencies of packed data, for example, it is possible to use a condition for determining whether one or more packed data are output when the number of data (a threshold) set in advance is input to the compression processing circuits 18c′ of the channels corresponding to the respective kinds of data. The “number of data” is the number of unit data as a reference in original image data before compression. For example, the number of pixels or the number of lines of the pixels can be used as the number of data.

As a specific example of the number of data (the threshold) set in advance, for example, when packed data is generated by compressed data of a kind having a lowest generation frequency of packed data because a compression ratio is the highest among the five kinds of data including the data of the four components of CMYK and the Tag data, the number of pixels corresponding to data included in the packed data (a maximum allowable number of pixels of the packed data) or the number of pixels smaller than the number of pixels can be set as the threshold. This is because, when there is data from which no packed data is generated although the data is input by the maximum allowable number of pixels of the packed data, the data has an extremely high compression ratio and deviation of generation frequencies of the packed data is too large between the data and other kinds of data.

Specifically, for example, it is assumed that the data of CMYK is 1 byte per one pixel, the Tag data is 2 bits per one pixel, and a highest compression ratio is 1/100. In this case, a generation frequency of packed data is the lowest when the packed data is generated only by data obtained by compressing the Tag data at the highest compression ratio. When packed data is generated only by compressed data obtained by compressing the Tag data at the highest compression ratio (100 times), if a packed data size is 64 bytes, the number of pixels is calculated as (64−1) [bytes]×100×4 [pixels/byte]=25200 [pixels]. Therefore, when data input for 25200 pixels is performed with 25200 pixels as a threshold, it is possible to discriminate a generation frequency by determining, for each of the kinds of data, whether one or more packed data are output.

It is naturally possible to set the number of pixels smaller than the maximum allowable number of pixels of the packed data as the threshold. For example, when pixels in a quarter of one line of one page are set as a threshold, if the number of pixels in one line of one page is 8000, the number of pixels in the quarter line is 8000 [pixels]× 1/4=2000 [pixels]. When the threshold is 2000 pixels, since the number of pixels is smaller than the maximum allowable number of pixels of the packed data, it is possible to further reduce deviation of a generation frequency if the generation frequency is adjusted by monitoring, every time 2000 pixels are input, whether packed data is generated.

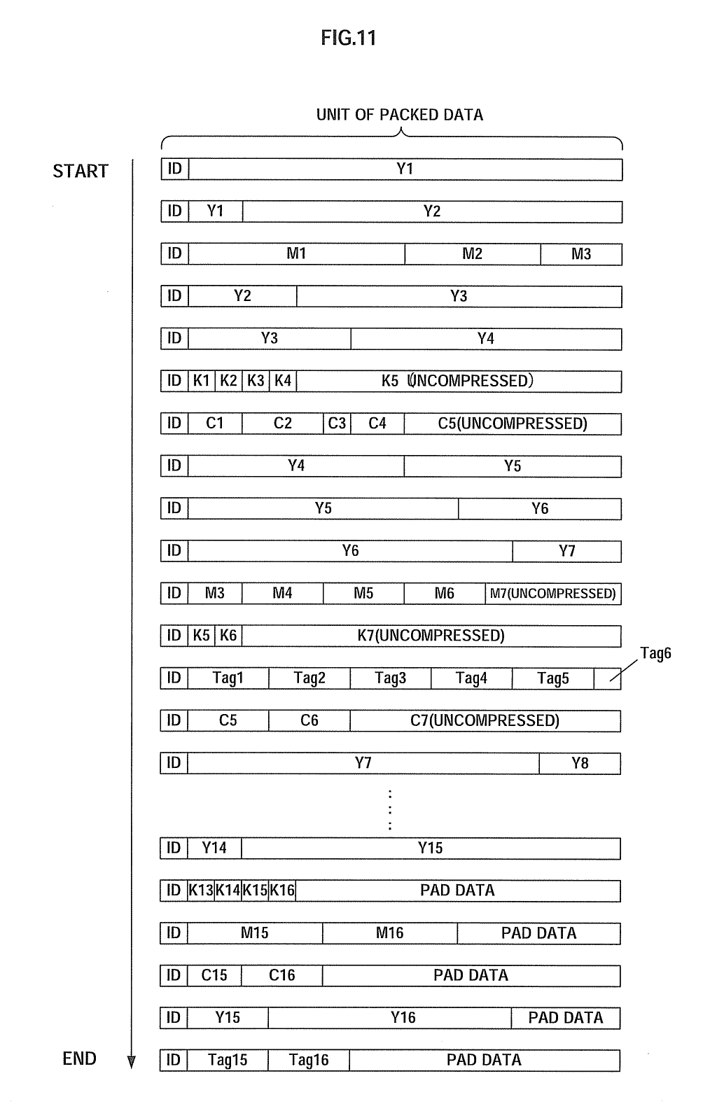

A data structure example in which compressed data is generated from image data having a large difference of compression ratios for each of kinds of data by the compressing unit 18b′ and the packed data unit 30′ in this embodiment is explained below. FIG. 11 is a diagram of the data structure of compressed data in this embodiment. As in FIG. 3 and the like, the compressed data are arranged from the top in order of output as packed data. According to this embodiment, uncompressed data is combined with data of the black component and the data of the cyan component that are data having high compression ratios. The packed data is output at timing not so delayed from output of the data of the yellow and magenta components. In this way, a frequency and timing of generation of packed data are adjusted between the data of yellow and magenta having low compression ratios and the data of black and cyan having high compression ratios. Therefore, it is possible to perform the expansion processing such that large deviation does not occur in timing when the expansion processing is completed.

The configuration and the functions of the MFP 1 according to this embodiment are as explained above. With the MFP 1 according to this embodiment, in addition to the effects of the first embodiment, when there is a large difference of compression ratios among the respective kinds of data of the packed data, it is possible to combine uncompressed data with data of a kind having high compression ratios at predetermined timing. Consequently, even when there is a large difference of compression ratios among the respective kinds of data, it is possible to output packed data of a kind having a high compression ratio at timing deviating little from timing when packed data of a kind having a low compression ratio is output. In other words, according to this embodiment, it is possible to eliminate deviation of a generation frequency of packed data caused by a difference of compression ratios. Therefore, in the expansion processing, it is possible to prevent large deviation from occurring in timing when the expansion processing ends and prevent time required for the expansion processing from becoming excessively long. Since large deviation does not occur in timing when the expansion processing ends, an effect can also be obtained that it is unnecessary to increase the capacity of the buffer of the expanding unit 19 for temporarily storing expanded data to be timed to coincide with timing when the expanded data is output to the page memory.

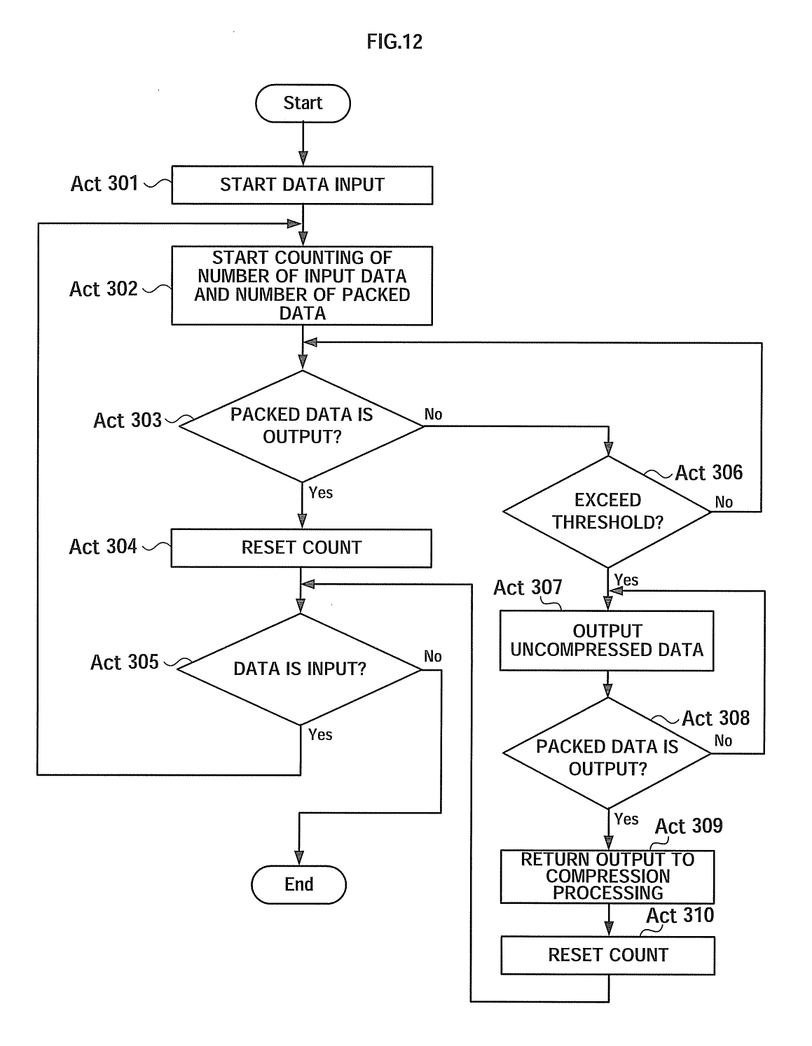

Flows of the compression processing and the expansion processing by the MFP 1 according to this embodiment are explained below. FIG. 12 is a flowchart for explaining the flow of the compression processing by the MFP 1 according to this embodiment.

First, in Act 301, the CPU 2 instructs the DMA circuits 18a of the channels of the compressing unit 18′ to read out data of components corresponding to the channels from image data generated and temporarily stored in the main memory 4 by the RIP processing, transfer the data to the flow-controlled FIFO circuits 18b having a function of buffers, and input the data to the compression processing circuits 18c′ of the channels.

Subsequently, in Act 302, the CPU 2 instructs the compression processing circuits 18c′ and the packed-data-generation control circuit 30b′ to execute, for each of the channels, counting processing for the number of input data by a number of input data counting function of the compression processing circuits 18c′ and counting processing for the number of output packed data by a number of packed data counting function of the packed-data-generation control circuit 30b′.

In Act 303, the CPU 2 causes the packed-data-generation control circuit 30b′ to determine whether packed data is output from the packed-data generating circuits 30a′ to the channels.

If packed data is output (Yes in Act 303), in Act 304, the CPU 2 resets a count value of the number of input data counting function of the compression processing circuit 18c′ of the target channel and a count value of the number of packed data counting function of the packed-data-generation control circuit 30b′.

In Act 305, the CPU 2 determines whether data is further input to the compression processing circuit 18c′

If data is input (Yes in Act 305), the CPU 2 returns to Act 302 and repeats the processing. If data is not input (No in Act 305), the CPU 2 ends the compression processing and the packed data processing assuming that the compression processing for all the data ends.

If the packed-data-generation control circuit 30b′ determines that packed data is not generated (No in Act 303), in Act 306, the CPU 2 determines whether the number of data input to the compression processing circuit 18c′ exceeds the threshold.

If the packed-data-generation control circuit 30b′ determines that the number of input data exceeds the threshold (Yes in Act 306), since it can be said that a generation frequency of packed data of data of the channel is low (generation time is delayed), in Act 307, the CPU 2 controls the compression processing circuit 18c′ of the corresponding channel to stop the compression processing and directly output the data as uncompressed data.

If the packed-data-generation control circuit 30b′ determines that the number of input data does not exceeds the threshold (No in Act 306), the CPU 2 returns to Act 303 and repeats the processing.

In a state in which the uncompressed data is output according to the processing in Act 307, in Act 308, the CPU 2 determines whether the data is output as packed data from the packed-data generating circuits 30a′ of the corresponding channel. If the uncompressed data is not output as packed data yet (No in Act 308), the CPU 2 returns to Act 307 and repeats the processing.

On the other hand, if the uncompressed data is output as packed data (Yes in Act 308), in Act 309, the CPU 2 causes the packed-data-generation control circuit 30b′ to control the compression processing circuit 18c′ of the corresponding channel to return the output of the uncompressed data to the normal output processing for compressed data.

In Act 310, the CPU 2 resets a count value of the number of input data counting function of the compression processing circuit 18c′ and a count value of the number of packed data counting function of the packed-data-generation control circuit 30b′. In Act 305, the CPU 2 determines whether data is further input to the compression processing circuit 18c′. As explained above, if data is input, the CPU 2 returns to Act 302 and repeats the processing. If data is not input, the CPU ends the compression processing and the packed data processing assuming that the compression processing for all the data ends.

The compression processing by the MFP 1 according to this embodiment and, in particular, the flow of the processing for adjusting a generation frequency (generation timing) of packed data is as explained above.

In the compression processing in this embodiment, the processing does not always progress in the order of the flow shown in FIG. 12. In some case, the kinds of processing included in the compression processing are executed in parallel by the circuits corresponding thereto.

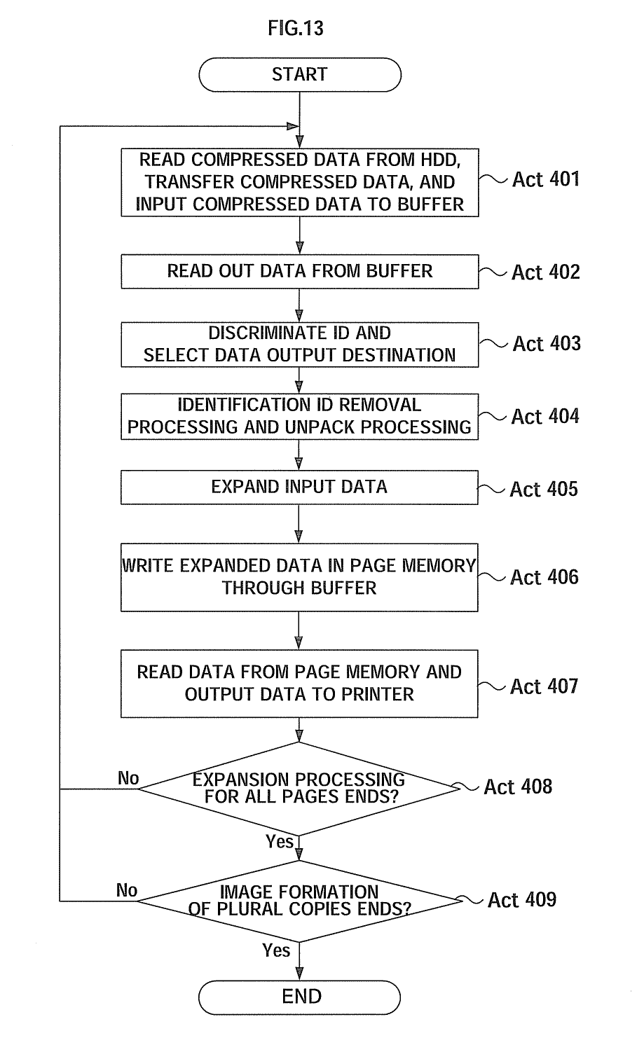

The flow of the expansion processing by the MFP 1 according to this embodiment is explained. FIG. 13 is a flowchart for explaining the flow of the expansion processing by the MFP 1 according to this embodiment.

First, in Act 401, the CPU 2 causes the first DMA circuit 19a to transfer compressed data from the HDD 6 to the buffer (the first FIFO circuit 19b)

Subsequently, in Act 402, CPU 2 instructs the compressed-data-path control circuit 19c to execute processing for reading out the compressed data from the buffer.

In Act 403, the CPU 2 discriminates a channel ID with the compressed-data-path control circuit 19c, discriminates a kind of data (i.e., any one of the four kinds of data corresponding to the color components of the four colors and the Tag data), and determines the channel of the expansion processing circuit 19d to which the compressed data is output.

In Act 404, the CPU 2 instructs the compressed-data-path control circuit 19c to execute unpack processing for removing the channel ID added to the packed data and releasing a pack state.

In Act 405, when the unpacked compressed data is output to the expansion processing circuit 19d corresponding thereto, the CPU 2 instructs the expansion processing circuit 19d to expand the compressed data.

In Act 406, the CPU 2 causes the page memory to temporarily store the expanded data through the buffer (the second FIFO circuit 19e) according to the function of the second DMA circuit 19f or the like.

In Act 407, the CPU 2 instructs the image-data output unit 21 to read the data of the four components of CMYK and the Tag data for one page from the page memory and output the data to the image forming unit 8.

In Act 408, the CPU 2 determines whether the expansion processing ends for all pages included in a file acquired as a PDL file. If a page to be expanded still remains (No in Act 408), the CPU 2 returns to Act 401 and repeats the expansion processing. On the other hand, if the expansion processing ends for all the pages (Yes in Act 408), the CPU 2 proceeds to Act 409.

In Act 409, the CPU 2 determines whether electronic sort is set and it is necessary to further perform image formation of plural copies. If it is necessary to further perform the image formation with the electronic sort (No in Act 409), the CPU 2 returns to Act 401 and repeats the expansion processing again to perform the image formation processing. If electronic sort is not set and it is unnecessary to further perform image formation (Yes in Act 409), the CPU 2 ends the processing.

The flow of the expansion processing by the MFP 1 according to this embodiment is as explained above.

According to this embodiment explained above, when one compressed data in which packed data are arranged in order of generation is generated, it is possible to prevent large deviation from occurring in timing when packed data is output among the channels. Consequently, since the expansion processing is performed with little deviation of time when the expansion processing ends among the channels, as a result, it is possible to prevent time for the expansion processing from becoming long. Since deviation of timing of the expansion processing is little, an effect can also be obtained that it is unnecessary to provide a high-cost and large-capacity buffer as the buffer for temporarily storing expanded data. Therefore, with the MFP 1 according to this embodiment, even when compression ratios are substantially different among kinds of data, it is possible to perform electronic sort printing for a high-quality image with printing speed maintained.

In this embodiment, it is explained that, concerning the channel having a high compression ratio and delayed timing when packed data is output, uncompressed data is output to adjust the timing. However, the present invention is not limited to this. An output frequency of packed data may be adjusted not only by combining normal compression and un-compression but also by changing a compression ratio.

### Third Embodiment

A third embodiment is explained below. As in the case of the second embodiment, the MFP 1 according to this embodiment adjusts frequencies (timings) of generation of packed data of channels such that timing when the expansion processing end does not substantially deviate when a difference of compression ratios increases. The third embodiment is a modification of the second embodiment. In this embodiment, for adjustment of generation timing of packed data, processing for inserting invalid data is performed instead of outputting uncompressed data. A configuration and functions of this embodiment are explained below. Components same as those in the first and second embodiments are denoted by the same reference numerals and signs and explanation of the components is omitted.

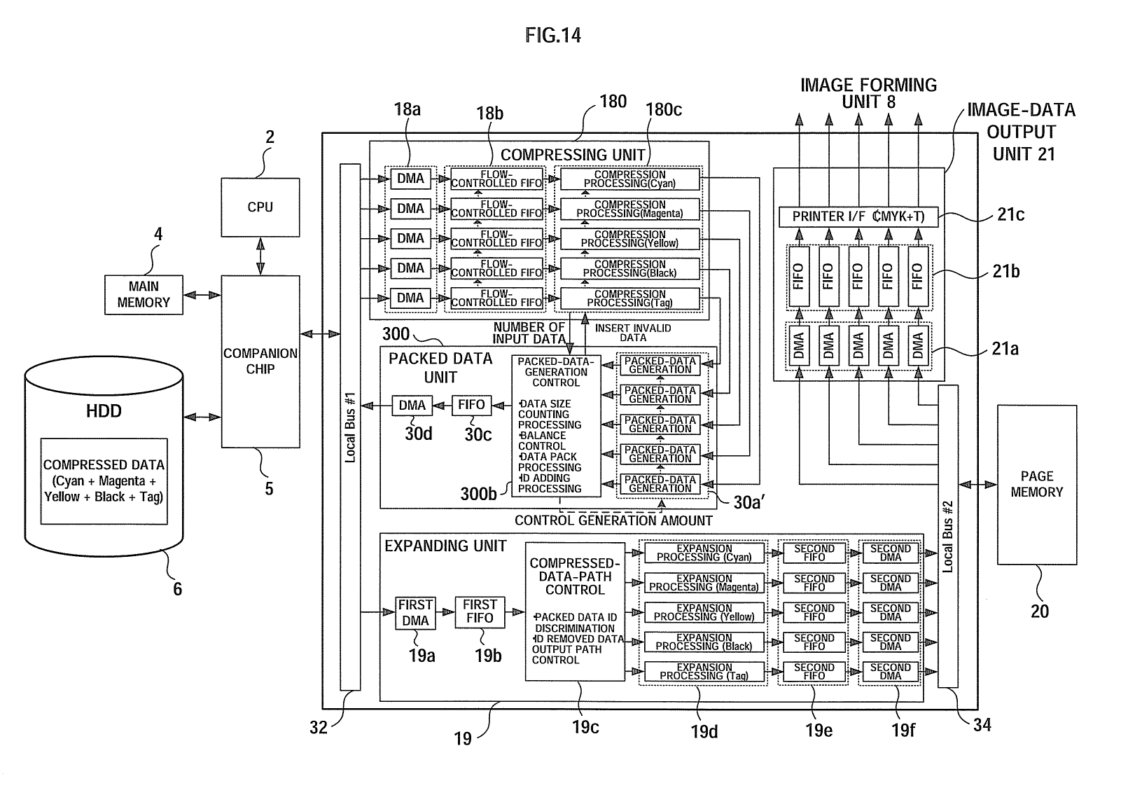

FIG. 14 is a control block diagram for explaining functions of the MFP 1 according to this embodiment. The MFP 1 according to this embodiment includes a compressing unit 180 and a packed data unit 300 having functions different from the counterparts in the second embodiment. The expanding unit 19 and the image-data output unit 21 are the same as those in the second embodiment.

The compressing unit 180 includes the DMA circuits 18a, the flow-controlled FIFO circuits 18b, and compression processing circuits 180c. Since the DMA circuits 18a and the flow-controlled FIFO circuits 18b have configurations same as those in the second embodiment, explanation thereof is omitted. When there is a kind of data, output of packed data of which is delayed, the compression processing circuit 180c of a channel corresponding to the data performs processing for inserting invalid data in compressed data on the basis of an instruction of a packed-data-generation control circuit 300b explained later. The “invalid data” is, for example, like the PAD data, data including Invalid data indicating that data is invalid data, number of invalid bits data indicating the number of bits of the invalid data, and invalid data for the number of invalid bits, for example, data such as “0”.

The packed data unit 300 includes the packed-data generating circuits 30a′, the packed-data-generation control circuit 300b, the FIFO circuit 30c, and the DMA circuit 30d. Since the packed-data generating circuits 30a′ are the same as those in the second embodiment and the FIFO circuit 30c and the DMA circuit 30d are the same as those in the first embodiment, explanation thereof is omitted. As in the second embodiment, the packed-data-generation control circuit 300b determines whether the number of input data to the compression processing circuit 180c acquired from the compression processing circuit 180c for each of the channels exceeds a threshold. If the number of input data exceeds the threshold, the packed-data-generation control circuit 300b determines whether packed data is already output.

When there is a channel in which the number of input data exceeds the threshold and packed data is not output, since timing when packed data is output is delayed, the packed-data-generation control circuit 300b controls the compression processing circuit 180c of the channel to insert invalid data.

When the compressed processing circuit 180c of the corresponding channel inserts invalid data on the basis of this control, a capacity of a buffer of the packed-data generating circuit 30a′ of the channel is immediately filled by the inserted invalid data. Therefore, it is possible to output packed data from the channel.

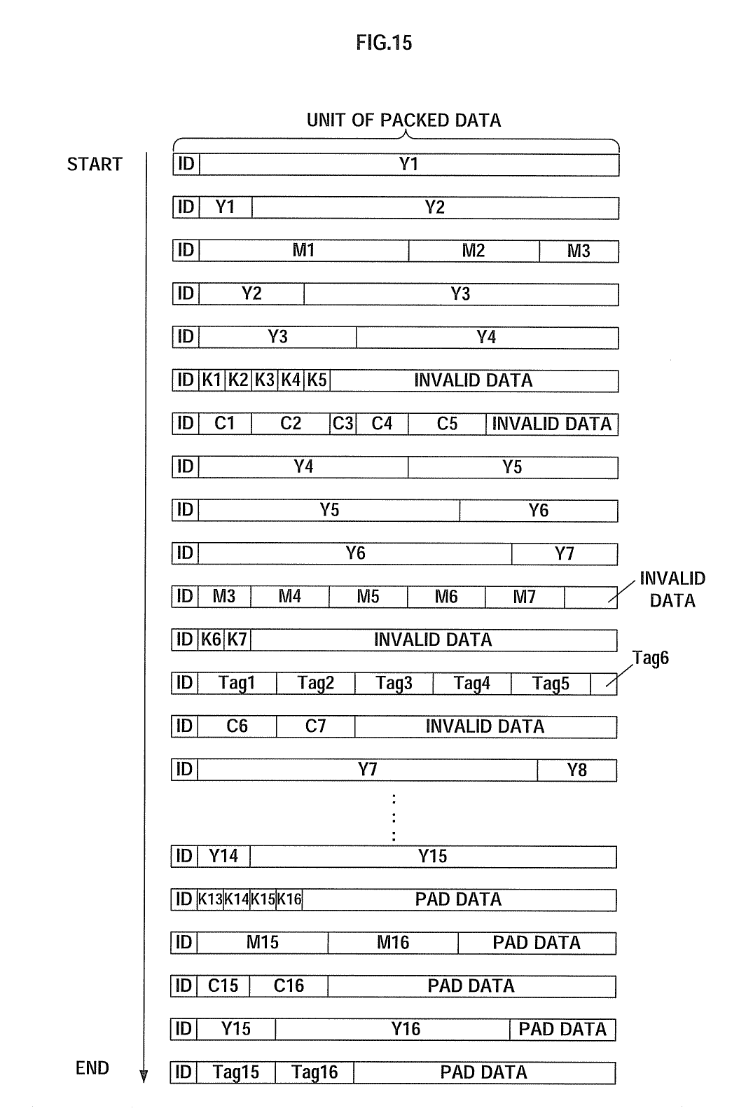

The data structure of compressed data generated by the functions of the compressing unit 180 and the packed data unit 300 explained above is shown in FIG. 15. Invalid data is inserted in data in which generation of packed data of black, cyan, and the like is delayed. Consequently, as in the case of the insertion of the uncompressed data in the second embodiment shown in FIG. 11, it is possible to forcibly fill a buffer of a channel in which generation of packed data is delayed and output compressed data as packed data.

Therefore, according to this embodiment, as in the embodiments explained above, deviation of timing when the expansion processing for compressed data ends is prevented from increasing among the kinds of data. The expansion processing is not excessively extended and a large-capacity buffer for storing extended data is unnecessary. Therefore, with the MFP 1 according to this embodiment, even when compression ratios are substantially different among the kinds of data, it is possible to perform electronic sort printing of a high-quality image with printing speed maintained.

### Fourth Embodiment

A fourth embodiment is explained below. As in the second and third embodiments, the MFP 1 according to this embodiment adjusts frequencies (timings) of generation of packed data of channels when a generation frequency and generation timing of packed data are delayed. The MFP 1 according to this embodiment adjusts an amount of data itself input to the compression processing circuits 18c and adjusts generation timing of packed data. A configuration and functions of this embodiment are explained below. Components same as those in the first to third embodiments are denoted by the same reference numerals and signs and explanation of the components is omitted.

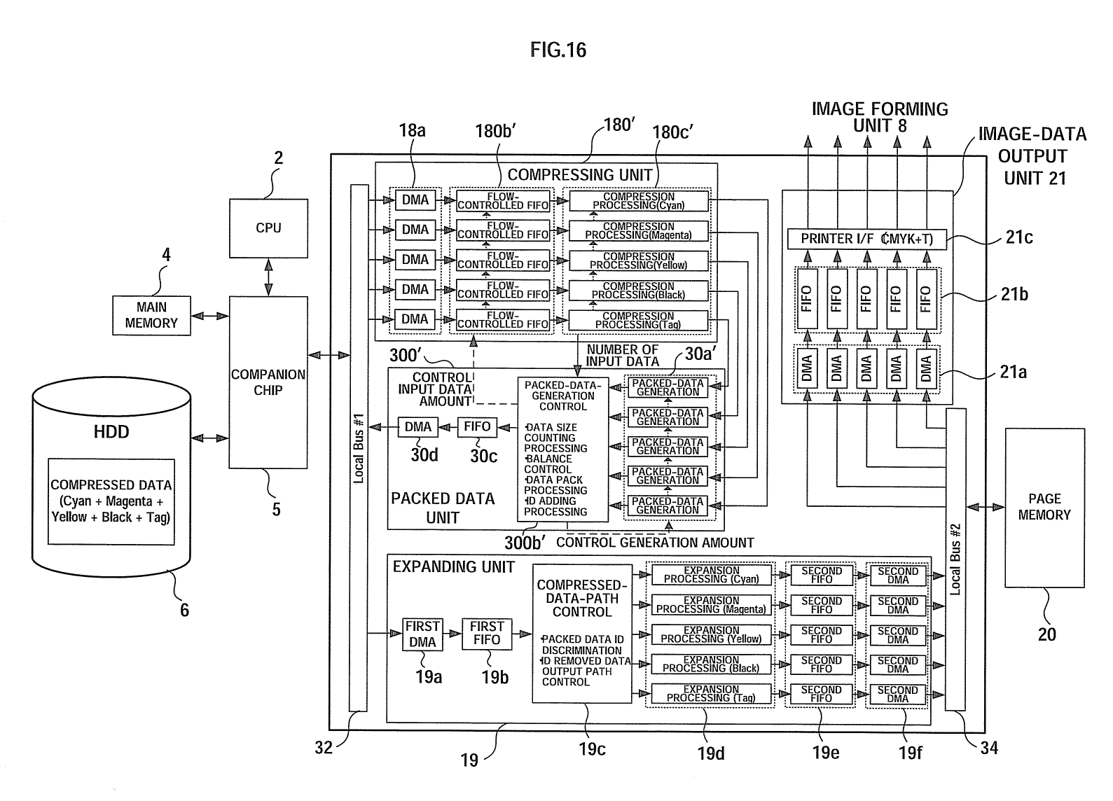

FIG. 16 is a control block diagram for explaining the functions of the MFP 1 according to this embodiment. The MFP 1 according to this embodiment includes a compressing unit 180′ and a packed data unit 300′ having functions different from the counterparts in the second and third embodiments. The expanding unit 19 and the image-data output unit 21 are the same as those in the second embodiment.

The compressing unit 180′ in this embodiment includes a function of adjusting an amount of data input to the compression processing circuit 18c on the basis of an instruction of a packed-data-generation control circuit 300b′ explained later. The compressing unit 180′ includes the DMA circuits 18a, the flow-controlled FIFO circuits 180b′, and the compression processing circuits 180c′. Since the DMA circuits 180a are the same as those in the first embodiment, explanation thereof is omitted.

The flow-controlled FIFO circuits 180b′ adjust an amount of data input to the compression processing circuits 180c′ according to the control by the packed-data-generation control circuit 300b′.

The compression processing circuits 180c′ subject data input from the flow-controlled FIFO circuits 180b′ to the compression processing. However, in the case of this embodiment, the input of the data from the flow-controlled FIFO circuits 180b′ is adjusted according to amounts of generation of packed data. Therefore, when the input of the data is stopped, the compression processing circuits 180c′ also stop the compression processing and stop accumulation of compressed data in the buffers of the packed-data generating circuits 30a′. Consequently, while the compression processing is stopped, packed data of a channel in which generation of the packed data is delayed is output and the balance of amounts of generation of packed data among the channels is adjusted.

As in the second and third embodiments, the packed data unit 300′ determines whether the number of data before compression input to the compression processing circuits 180c′ exceeds a threshold. If the number of data exceeds the threshold, the packed data unit 300′ determines whether packed data is already output. If there is a channel in which the number of data exceeds the threshold and packed data is not output, since timing when packed data is output is delayed, the packed data unit 300′ stops the data input to the compression processing circuits 180c′ using a flow control function of the flow-controlled FIFO circuits 180b′ of the channels other than the channel in which the output of packed data is delayed.

The packed data unit 300′ is an ASIC and includes the packed-data generating circuits 30a′, the packed-data-generation control circuit 300b′, the FIFO circuit 30c, and the DMA circuit 30d. As explained above, the packed-data-generation control circuit 300b′ determines whether the number of input data to the compression processing circuit 180c′ acquired from the compression processing circuit 180c′ for each of the channels exceeds the threshold and, if the number of input data exceeds the threshold, determines whether packed data is already output. If there is a channel in which the number of input data exceeds the threshold and packed data is not output, since timing when packed data is output is delayed, the packed-data-generation control circuit 300b′ performs processing for causing the flow-controlled FIFO circuits 180b′ of the channels other than the channel to stop output of data to the compression processing circuits 180c′.

As explained above, by adjusting an amount of data input to the compression processing circuits 180c′, it is also possible to relatively increase a generation frequency of packed data concerning data corresponding to a channel in which generation of packed data is delayed and a generation frequency of packed data is low. Therefore, it is possible to adjust the balance of generation of packed data among the data. Consequently, it is possible to solve the problems in that, in the expansion processing, timing when the expansion processing ends deviates and a large-capacity buffer has to be prepared. Therefore, with the MFP 1 according to this embodiment, even when compression ratios are substantially different among kinds of data, it is possible to perform electronic sort processing for a high-quality image with printing speed maintained.

### Fifth Embodiment

A fifth embodiment is explained below. The MFP 1 according to this embodiment includes, in each of channels, plural compression processing circuits of a compressing unit, plural packed-data generating circuits of a packed data unit, and plural expansion processing circuits of an expanding unit such that smooth compression and expansion processing can be performed even when an amount of data subjected to the compression processing and the expansion processing is large and a processing ability is insufficient. A configuration and functions of this embodiment are explained below. Components same as those in the first to fourth embodiments are denoted by the same reference numerals and signs and explanation of the components is omitted.

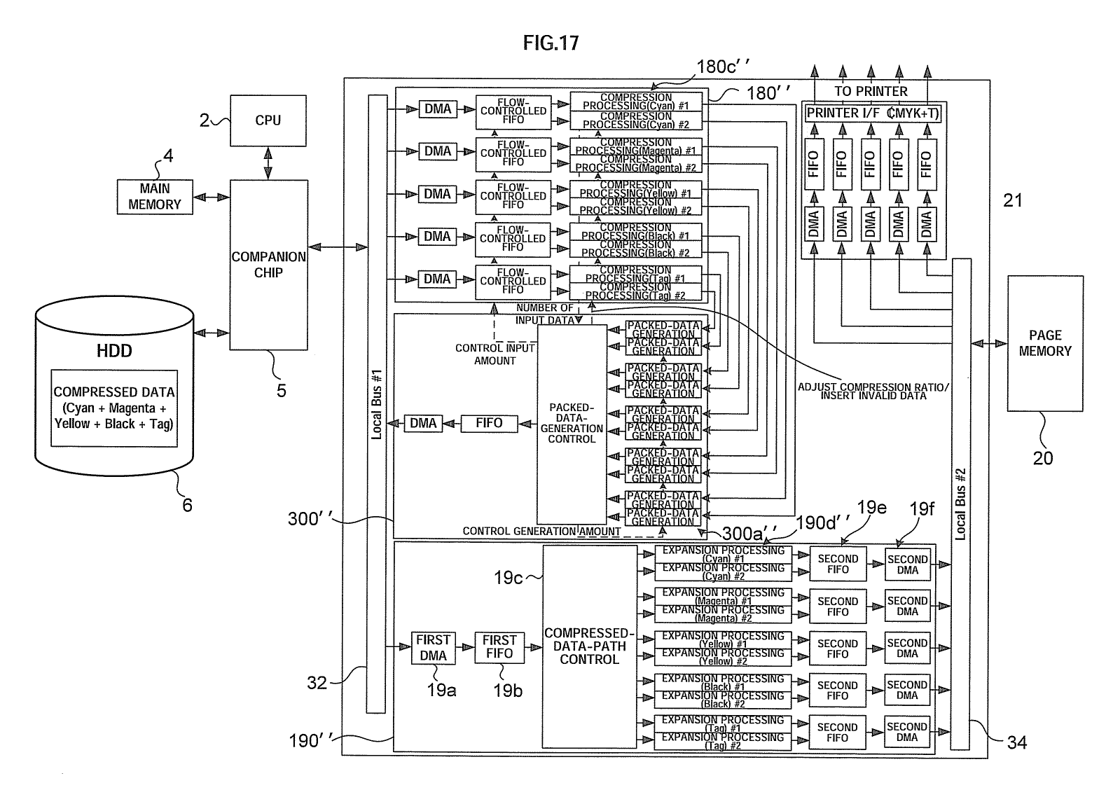

FIG. 17 is a control block diagram for explaining the functions of the MFP 1 according to this embodiment. The MFP 1 according to this embodiment includes a compressing unit 180″, a packed data unit 300″, an expanding unit 190″, and the image-data output unit 21. Since the image-data output unit 21 is the same as that in the first embodiment and the like, explanation thereof is omitted.

As in the other embodiments explained above, the compressing unit 180″ performs processing for reading image data stored in the main memory 4 and compressing the image data for each of kinds of data.

The compressing unit 180″ in this embodiment includes two compression processing circuits 180c″ in each of the channels. Consequently, it is possible to perform the compression processing without a fall in processing speed even if an amount of data to be compressed increases.

The packed data unit 300″ performs processing for packing compressed data output from the compression processing circuits 180c″ as a fixed volume of data for each of the kinds, outputting the compressed data as packed data, and causing the HDD 6 to store the packed data as a series of one compressed data in which the packed data is arranged in order of generation.

The packed data unit 300″ in this embodiment also includes two compression processing circuits 300a″ in each of the channels to correspond to the two compression processing circuits 180c″ provided in each of the channels. Consequently, the packed-data generating circuits 300a″ corresponding to the compression processing circuits 180c″ can pack the compressed data output from the compression processing circuits 180c″ at a fixed size and output the compressed data. Therefore, it is possible to quickly execute pack processing even if an amount of data increases.

In the MFP 1 according to this embodiment in which the two compression processing circuits 180c″ and the two packed-data generating circuits 300a″ are provided in each of the channels, according to the processing explained in the second to fourth embodiments, it is possible to adjust generation timing of packed data when there is a channel in which a generation frequency of packed data is low because of a difference of compression ratios.

The expanding unit 190″ includes the first DMA circuit 19a, the first FIFO circuit 19b, the compressed-data-path control circuit 19c, expansion processing circuits 190d″, the second FIFO circuits 19e, and the second DMA circuits 19f. Expansion processing executed by the expanding unit 190″ is the same as the expansion processing in the other embodiments explained above. However, since two expansion processing circuits 190d″ are provided in each of the channels, it is possible to prevent speed of the expansion processing from falling even if an amount of data to be processed increases.

The configuration and the functions of the MFP 1 according to this embodiment are as explained above.

Therefore, according to this embodiment, even when a data amount increases and the compression processing and the expansion processing are performed to perform electronic sort or the like, it is possible to perform printing without a fall in printing speed and while maintaining image quality. Even if a large difference occurs in compression ratios among the five kinds of data including the color data of the four components and the Tag data, it is possible to adjust generation timing of packed data by applying the various methods explained above. Therefore, an effect can be obtained that time for the expansion processing does not become long and a large-capacity buffer is not necessary.

In a computer included in an image processing apparatus, a computer program for causing the computer to execute the operations explained in the first to fifth embodiments can be provided as an image processing program.

The present invention can be carried out in various forms without departing from the spirit or the main characteristics thereof. Therefore, the embodiments explained above are merely simple illustrations in every aspect and should not be limitedly interpreted. The scope of the present invention is indicated by the appended claims and is by no means limited by the text of the specification. Further, all alterations and various improvements, substitutions, and modifications belonging to the scope of equivalents of the claims are within the scope of the present invention.

As explained above in detail, according to the present invention, it is possible to provide an image processing apparatus that realizes the compression processing and the expansion processing at high speed and with image quality maintained.

What is claimed is:

1. An image processing apparatus comprising:
a color-data acquiring unit configured to acquire, for each of plural kinds of color components for defining colors of respective plural pixels that form bitmap image data set as a processing target, color data of the respective plural kinds of color components;
plural compression processing units separately provided in association with the respective plural kinds of color components and configured to compress in order, for each of the color components, the color data of the color components acquired by the color-data acquiring unit according to arraying order of the color data in the bitmap image data;
a packed-data generating unit configured to generate, for each of the color components, packed data as data packaged in the order of the compression by the compression processing unit while associating a predetermined volume of compressed data in which the data is arrayed in the order of the compression by the respective plural compression processing units and identification information indicating the color components corresponding to the compressed data; and
a combined-compressed-data output unit configured to output combined compressed data obtained by integrally combining a plurality of the packed data of the color components generated by the packed-data generating unit such that at least the packed data for each of the color components is arrayed in the order of the generation by the packed-data generating unit.

2. The apparatus according to claim 1, wherein the combined-compressed-data output unit outputs the combined compressed data obtained by integrally combining the plural packed data of the color components by arraying the packed data in the order of the generation by the packed-data generating unit.

3. The apparatus according to claim 1, wherein
the packed-data generating unit includes plural storage areas having a predetermined capacity respectively corresponding to the color components that respectively accumulate compressed data of the color components output from the plural compression processing units respectively corresponding to the color components, and
the packed-data generating unit outputs, if the predetermined volume of the compressed data is accumulated in the storage areas, the accumulated predetermined volume of the compressed data as the packed data in association with the identification information of the color components corresponding to the compressed data.

4. The apparatus according to claim 1, further comprising:
a combined-compressed-data acquiring unit configured to acquire the combined compressed data output by the combined-compressed-data output unit and stored in a predetermined storage area;
an identification-information determining unit configured to discriminate the identification information added to the packed data forming the combined compressed data acquired by the combined-compressed-data acquiring unit and determines to which of the color components the packed data added with the discriminated identification information corresponds;
plural expansion processing units respectively corresponding to the color components configured to respectively expand the packed data of the color components corresponding thereto; and
a packed-data output unit configured to output, on the basis of a determination result of the identification-information determining unit, the packed data, the identification information of which is discriminated, to the expansion processing units of the corresponding color components.

5. The apparatus according to claim 1, wherein the packed-data generating unit preferentially generates, on the basis of a difference of packed data generation frequencies as frequencies of generation of the packed data among the color components, the packed data of the color components, the packed data generation frequencies of which are low, to thereby eliminate deviation of the packed data generation frequencies.

6. The apparatus according to claim 5, further comprising:
a number-of-input-data counting unit configured to count, for each of the color components, numbers of the color data input to the plural compression processing units; and
a number-of-packed-data counting unit configured to count a number of generated packed data for each of the color components, wherein
the packed-data generating unit determines, for each of the color components, the packed data generation frequency on the basis of the numbers of data counted by the number-of-input-data counting unit and the number of generated packed data counted by the number-of-packed-data counting unit.

7. The apparatus according to claim 5, wherein the packed-data generating unit causes, on the basis of the difference of the packed data generation frequencies among the color components, the compression processing units corresponding to the color components having the low packed data generation frequencies to perform processing for directly outputting, in an uncompressed state, color data input to the compression processing units.

8. The apparatus according to claim 5, wherein the packed-data generating unit causes, on the basis of the difference of the packed data generation frequencies among the color components, the compression processing units corresponding to the color components having the low packed data generation frequencies to perform processing for inserting invalid data in the color data set as a compression processing target.

9. The apparatus according to claim 5, further comprising a data-input-amount control unit configured to control amounts of input of the color data of the color components to the plural compression processing units, wherein
the packed-data generating unit eliminates the deviation of the packed data generation frequencies by causing, on the basis of the difference of the packed data generation frequencies among the color components, the data-input-amount control unit to execute processing for adjusting the amounts of input of the color data to the compression processing units.

10. The apparatus according to claim 1, wherein the plural compression processing units and the packed-data generating unit corresponding to the compression processing units include plural circuits parallel to one another and process the compression of the color data and the generation of the packed data in parallel to each other.

11. An image forming apparatus comprising:
a color-data acquiring unit configured to acquire, for each of plural kinds of color components for defining colors of respective plural pixels that form bitmap image data set as a processing target, color data of the respective plural kinds of color components;
plural compression processing units separately provided in association with the respective plural kinds of color components and configured to compress in order, for each of the color components, the color data of the color components acquired by the color-data acquiring unit according to arraying order of the color data in the bitmap image data;
a packed-data generating unit configured to generate, for each of the color components, packed data as data packaged in the order of the compression by the compression processing unit while associating a predetermined volume of compressed data in which the data is arrayed in the order of the compression by the respective plural compression processing units and identification information indicating the color components corresponding to the compressed data; and
a combined-compressed-data output unit configured to output combined compressed data obtained by integrally combining a plurality of the packed data of the color components generated by the packed-data generating unit such that at least the packed data for each of the color components is arrayed in the order of the generation by the packed-data generating unit.

12. The apparatus according to claim 11, wherein
the packed-data generating unit includes plural storage areas having a predetermined capacity respectively corresponding to the color components that respectively accumulate compressed data of the color components output from the plural compression processing units respectively corresponding to the color components, and
the packed-data generating unit outputs, if the predetermined volume of the compressed data is accumulated in the storage areas, the accumulated predetermined volume of the compressed data as the packed data in association with the identification information of the color components corresponding to the compressed data.

13. The apparatus according to claim 11, further comprising:
a combined-compressed-data acquiring unit configured to acquire the combined compressed data output by the combined-compressed-data output unit and stored in a predetermined storage area;
an identification-information determining unit configured to discriminate the identification information added to the packed data forming the combined compressed data acquired by the combined-compressed-data acquiring unit and determines to which of the color components the packed data added with the discriminated identification information corresponds;
plural expansion processing units respectively corresponding to the color components configured to respectively expand the packed data of the color components corresponding thereto;
a packed-data output unit configured to output, on the basis of a determination result of the identification-information determining unit, the packed data, the identification information of which is discriminated, to the expansion processing units of the corresponding color components; and
an image forming unit configured to form an image from data generated by expansion processing of the plural expansion processing unit.

14. The apparatus according to claim 11, wherein the packed-data generating unit preferentially generates, on the basis of a difference of packed data generation frequencies as frequencies of generation of the packed data among the color components, the packed data of the color components, the packed data generation frequencies of which are low, to thereby eliminate deviation of the packed data generation frequencies.

15. The apparatus according to claim 14, wherein the packed-data generating unit causes, on the basis of the difference of the packed data generation frequencies among the color components, the compression processing units corresponding to the color components having the low packed data generation frequencies to perform processing for directly outputting, in an uncompressed state, color data input to the compression processing units.

16. An image processing method comprising:
acquiring, with processing circuits, for each of plural kinds of color components for defining colors of respective plural pixels that form bitmap image data set as a processing target, color data of the respective plural kinds of color components;
compressing in order, with the processing circuits, for each of the color components, the acquired color data of the color components according to arraying order of the color data in the bitmap image data;
generating, for each of the color components, packed data as data packaged in the order of the compression while associating a predetermined volume of compressed data in which the data is arrayed in the order of the compression and identification information indicating the color components corresponding to the compressed data; and
outputting combined compressed data obtained by integrally combining a plurality of the generated packed data of the color components such that at least the packed data for each of the color components is arrayed in the order of the generation as the packed data.

17. The method according to claim 16, further comprising accumulating, with the processing circuits, output compressed data of the color components respectively in plural storage areas having a predetermined capacity corresponding to the color components and outputting, if the predetermined volume of the compressed data is accumulated in the storage areas, the accumulated predetermined volume of the compressed data as the packed data in association with the identification information of the color components corresponding to the compressed data.

18. The method according to claim 16, further comprising:
acquiring, with the processing circuits, the combined compressed data output and stored in a predetermined storage area;
discriminating, with the processing circuits, the identification information added to the packed data forming the acquired combined compressed data and determining to which of the color components the packed data added with the discriminated identification information corresponds; and
respectively expanding, with the processing circuits, the packed data of the color components corresponding thereto.

19. The method according to claim 16, further comprising preferentially generating, on the basis of a difference of packed data generation frequencies as frequencies of generation of the packed data among the color components, the packed data of the color components, the packed data generation frequencies of which are low, to thereby eliminate deviation of the packed data generation frequencies.

20. The method according to claim 19, further comprising directly outputting, with the processing circuits, on the basis of the difference of the packed data generation frequencies among the color components, color data as a compression processing target corresponding to the color components having the low packed data generation frequencies in an uncompressed state.
